(19) United States
(12) Patent Application Publication
(10) Pub. No.: US 2026/0129273 A1
(43) Pub. Date: May 7, 2026

(54) CAMERA DEVICE AND OPTICAL DEVICE

(71) Applicant: LG INNOTEK CO., LTD., Seoul (KR)

(72) Inventor: Hyun Soo KIM, Seoul (KR)

(21) Appl. No.: 18/993,908

(22) PCT Filed: Jul. 3, 2023
(86) PCT No.: PCT/KR2023/009300

§ 371 Date: Dec. 2, 2025

(30) Foreign Application Priority Data
Jul. 13, 2022 (KR) 10-2022-0086506

(51) Int. Cl. H04N 23/54; H04N 23/52

(52) U.S. Cl. CPC H04N 23/54; H04N 23/52

(57) ABSTRACT

Embodiments includes a stationary unit including a second circuit board and a coil disposed on the second circuit board, a moving unit including a holder, a magnet coupled to the holder, a first circuit board disposed on the holder, and an image sensor conductively connected to the first circuit board, and a support board disposed between the first circuit board and the second circuit board such that the moving unit is movable relative to the stationary unit, wherein the magnet is disposed between the first circuit board and the second circuit board.

### TECHNICAL FIELD

Embodiments relate to a camera device and an optical device including the same.

### BACKGROUND ART

It is difficult to apply technology of a voice coil motor (VCM) used in existing general camera devices to a subminiature, low-power camera device, and therefore research related thereto has been actively conducted.

Demand for and production of electronic products, such as smartphones and mobile phones equipped with cameras have increased. Cameras for mobile phones are trending toward increased resolution and miniaturization. As a result, an actuator has also been miniaturized, increased in diameter, and been made multifunctional. In order to realize a high-resolution camera for mobile phones, improvement in performance of the camera for mobile phones and additional functions thereof, such as autofocusing, hand shake correction, and zooming, are required.

### DISCLOSURE

### Technical Problem

Embodiments provide a camera module and an optical device which are capable of reducing a distance between an image sensor and a lens barrel, reducing a length in the optical axis direction, and improving heat dissipation efficiency.

### Technical Solution

A camera device according to an embodiment includes a stationary unit comprising a second circuit board and a coil disposed on the second circuit board; a moving unit comprising a holder, a magnet coupled to the holder, a first circuit board disposed on the holder, and an image sensor conductively connected to the first circuit board; and a support board disposed between the first circuit board and the second circuit board such that the moving unit is movable relative to the stationary unit, wherein the magnet is disposed between the first circuit board and the second circuit board.

The image sensor may be positioned higher than the magnet. The stationary unit may include a first heat dissipation member disposed between the image sensor and the second circuit board. The holder may include a recess formed a lower surface thereof, and the magnet is disposed in the recess of the holder. The first circuit board may include a terminal disposed on an upper surface thereof and conductively connected to the image sensor.

A groove may be formed in an upper surface of the holder, and the first circuit board may be disposed in the recess of the holder.

The moving unit may include a third circuit board disposed on the first circuit board, and the image sensor may be conductively connected to the third circuit board.

The image sensor may be disposed at an upper side of the first circuit board. A lower surface of the image sensor may be positioned higher than an upper surface of the first circuit board. The third circuit board may include an opening, at least a portion of the image sensor may be disposed in the opening of the third circuit board. The moving unit may include a second heat dissipation member disposed below the opening of the third circuit board, and the image sensor may be disposed on the second heat dissipation member.

The stationary unit may include a housing that accommodates the moving unit and is coupled with the second circuit board, and the support board may be coupled with the housing and the holder.

A portion of the support board may be connected to the first circuit board, and another portion of the support board may be connected to the second circuit board.

A camera device according to another embodiment includes a stationary unit including a second circuit board, a coil disposed on the second circuit board, and a first heat dissipation member disposed on the second circuit board; a moving unit including a holder, a magnet disposed on the holder, a first circuit board disposed on an upper surface of the holder, a third circuit board including a first hole and disposed on the first circuit board, a second heat dissipation member disposed under the second circuit board, and an image sensor disposed on a part of the first heat dissipation member opened by the first hole; and a support board connected to the second circuit board and the first circuit board.

The first heat dissipation member may include an upper plate and a side plate disposed between the upper plate and the second circuit board.

The coil may include a plurality of coil units disposed on an upper surface of the second circuit board and spaced apart from each other, and the plurality of coil units may be disposed to surround the first heat dissipation member.

The upper surface of the upper plate may be positioned higher than an upper surface of the coil. An upper surface of the upper plate may be positioned higher than an upper surface of the magnet.

The first heat dissipation member may include a support plate connected to the side plate and coupled to the second circuit board, and a width of the support plate may be larger than a width of the side plate.

The stationary unit may include a housing that accommodates the moving unit and is coupled to the second circuit board.

A portion of the support board may be coupled to the holder, and another portion of the support board may be coupled to the housing.

The first circuit board may include a first terminal formed on an upper surface thereof, and the third circuit board may include a second terminal formed on a side surface thereof, and the first terminal and the second terminal may be coupled to each other by solder.

A camera device according to another embodiment includes a stationary unit including a second circuit board; a moving unit including a holder, a first circuit board disposed on the holder; and an image sensor conductively connected to the first circuit board; a driving unit configured to move the moving unit; and a support board connected to the stationary unit and the moving unit, wherein the image sensor is positioned higher than the driving unit.

A camera device according to another embodiment includes a second circuit board; a holder disposed on the second circuit board; a coil including at least a portion disposed between the holder and the second circuit board; a magnet including at least a portion disposed between the holder and the second circuit board; a first circuit board disposed on the holder; and a support board connecting the first circuit board and the second circuit board, wherein the magnet is disposed between the first circuit board and the second circuit board. The magnet may be disposed between the image sensor and the second circuit board. The first circuit board may include a terminal which is disposed on an upper surface thereof and conductively connected to the image sensor.

### Advantageous Effects

In the embodiment, since the image sensor is disposed on an upper side of the first circuit board of the first substrate member, a distance between the lens barrel and the image sensor can be reduced, and a degree of freedom in the arrangement design of the lens barrel can be improved.

In the embodiment, the coil for driving the OIS can be disposed on the second substrate member which is the stationary unit, and the support board does not require a circuit pattern or wiring for electrical connection between the coil and the second substrate member.

In the embodiment, a length of the support board in the optical axis direction can be reduced, and a length of the camera device in the optical axis direction can be reduced, so that the size of the camera device can be reduced.

In the embodiment, by increasing a height of the second heat dissipation member with respect to the upper surface of the second substrate member in accordance with the increased height of the first heat dissipation member, the heat dissipation efficiency can be prevented from decreasing and the heat dissipation efficiency can be increased.

### DESCRIPTION OF DRAWINGS

FIG. 1 is a perspective view of a camera device according to an embodiment;

FIG. 2 is a perspective view of a camera device with the cover member removed.

FIG. 3A is a first separated perspective view of the camera device in FIG. 1.

FIG. 3B is a second separated perspective view of the camera device of FIG. 1.

FIG. 4A is a perspective view of the first elastic member and the housing.

FIG. 4B is a bottom perspective view of the housing.

FIG. 5A is a separated perspective view of the second circuit board, the image sensor, and the heat dissipation member.

FIG. 5B is a rear assembled perspective view of the second circuit board, the image sensor, and the heat dissipation member.

FIG. 6 is a separated perspective view of the second circuit board to which the image sensor and the heat dissipation member are coupled and the first circuit board to which the support board is coupled.

FIG. 7 is an assembled perspective view of the second circuit board and the first circuit board of FIG. 6.

FIG. 8A is a first perspective view of the holder.

FIG. 8B is a second perspective view of the holder.

FIG. 9 is a perspective view of the first substrate member of FIG. 7 coupled to the holder.

FIG. 10 is a perspective view of the first elastic unit of the third elastic member.

FIG. 11 is a perspective view of the third elastic member and the magnet coupled to the holder of FIG. 7.

FIG. 12 is an assembled perspective view of the support board and the housing of FIG. 11.

FIG. 13A is a perspective view of the second substrate member, the magnet, the coil, and the heat dissipation member.

FIG. 13B shows an embodiment of the heat dissipation member.

FIG. 14A is a cross-sectional view in the AB direction of FIG. 1.

FIG. 14B is a cross-sectional view in the CD direction of FIG. 1.

FIG. 14C is a cross-sectional view in the EF direction of FIG. 1.

FIG. 14D is a cross-sectional view in the GH direction of FIG. 1.

FIG. 15A is for explaining the movement of the moving unit in the X-axis direction.

FIG. 15B is for explaining the movement of the moving unit in the Y-axis direction.

FIG. 15C is for explaining the clockwise rotation of the moving unit when the 4-channel driving is performed.

FIG. 15D is for explaining the counterclockwise rotation of the moving unit when the 4-channel driving is performed.

FIG. 16 shows a simplified cross-sectional view of the first substrate member, the image sensor, and the second substrate member.

FIG. 17 shows a block diagram regarding the configuration of the controller, the coil units, and the first to third sensors.

FIG. 18 shows a separated perspective view of a camera device according to an embodiment.

FIG. 19A shows a perspective view of an optical device according to an embodiment.

FIG. 19B shows a perspective view of an optical device according to another embodiment.

FIG. 20 shows a configuration diagram of the optical device illustrated in FIGS. 19A and 19B.

### BEST MODE

Hereinafter, embodiments of the present invention will be described in detail with reference to the accompanying drawings.

The technical idea of the present invention may be embodied in many different forms, and should not be construed as being limited to the following embodiments set forth herein. One or more of components of the embodiments may be selectively combined with each other or replaced without departing from the technical spirit and scope of the present invention.

Unless otherwise particularly defined, terms (including technical and scientific terms) used in the embodiments of the present invention have the same meanings as those commonly understood by one of ordinary skill in the art to which this invention belongs. It will be further understood that commonly used terms, such as those defined in dictionaries, should be interpreted as having meanings consistent with their meanings in the context of the relevant art.

The terminology used in the embodiments of the present invention is for the purpose of describing particular embodiments only, and is not intended to limit the present invention. As used in the disclosure and the appended claims, the singular forms are intended to include the plural forms as well, unless the context clearly indicates otherwise. The phrase “at least one (or one or more) of A, B and C” may be interpreted as including one or more of all combinations of A, B and C.

Furthermore, when describing the components of the present invention, terms such as “first”, “second”, “A”, “B”, “(a)” or “(b)” may be used. Since these terms are provided merely for the purpose of distinguishing the components from each other, they do not limit the nature, sequence or order of the components.

It should be understood that, when an element is referred to as being “linked”, “coupled” or “connected” to another element, the element may be directly “linked”, “coupled” or “connected” to the another element, or may be “linked”, “coupled” or “connected” to the another element via a further element interposed therebetween. Furthermore, it will be understood that, when an element is referred to as being formed “on” or “under” another element, it can be directly “on” or “under” the other element, or can be indirectly disposed with regard thereto, with one or more intervening elements therebetween. In addition, it will also be understood that “on” or “under” the element may mean an upward direction or a downward direction based on the element.

Hereinafter, an AF driving unit may be alternatively referred to as a “lens driving apparatus”, a “lens moving unit”. Hereinafter, the term “coil” may be interchangeably used with “coil unit”, and the term “elastic member” may be interchangeably used with “elastic unit” or “spring”.

In the follow description, the “terminal” may be alternatively referred to as a “pad”, “electrode”, “conductive layer” or “bonding portion”.

In the following description, the terms “substrate member”, “printed circuit board”, “circuit board”, and “board” may be used interchangeably with one another.

For the convenience of description, although the camera module according to an embodiment is described using a rectangular coordinate system (x, y, z), the lens moving apparatus may be described using some other coordinate systems, and the embodiments are not limited thereto. In the respective drawings, the X-axis direction and the Y-axis direction mean directions perpendicular to an optical axis, i.e. the Z-axis, and the optical-axis direction may be a direction identical to or parallel to the optical axis OA. The Z-axis direction, which is the direction of the optical axis OA, may be referred to as a “first direction”, the X-axis direction may be referred to as a “second direction”, and the Y-axis direction may be referred to as a “third direction”. Furthermore, for example, the x-axis direction may be represented as “one of a first horizontal direction and a second horizontal direction”, and the y-axis direction may be represented as “the other of the first horizontal direction and the second horizontal direction”.

For example, the optical axis may be the optical axis of a lens mounted on a lens barrel. The first direction may be a direction perpendicular to an imaging area or an active area of an image sensor. Furthermore, the optical-axis direction may be a direction parallel to the optical axis.

The camera device according to the embodiment may perform a function of “hand shake correction” or OIS (Optical Image Stabilization). Here, the function of “hand shake correction” may serve to prevent the contour line of a captured image from being blurred due to vibration caused by shaking of the user's hand when capturing a still image.

The camera device according to the embodiment may alternatively be referred to as a “camera module”, a “camera assembly”, a “camera unit”, a “camera”, an “imaging device”, or a “lens moving apparatus”, an “image sensor moving (driving) device”, an “image stabilization device”, or an “OIS device”.

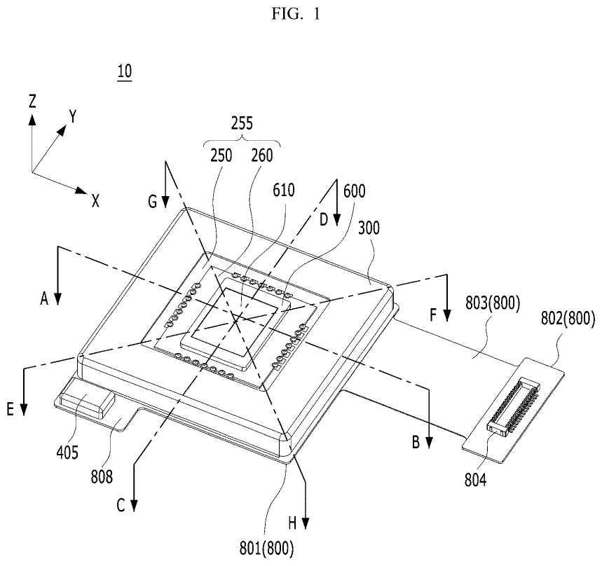

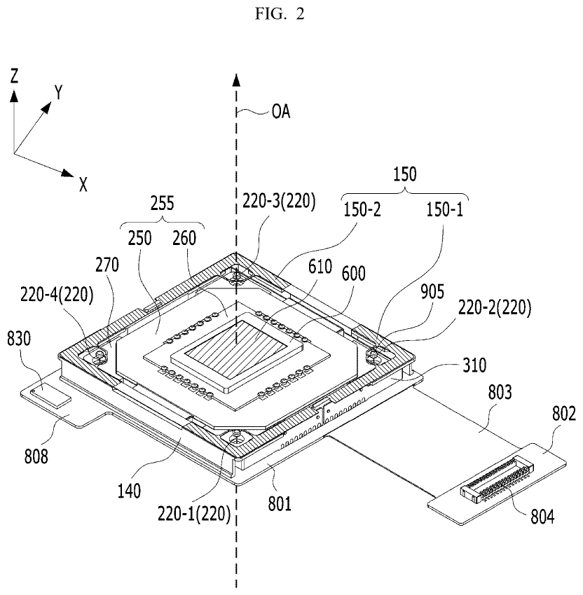

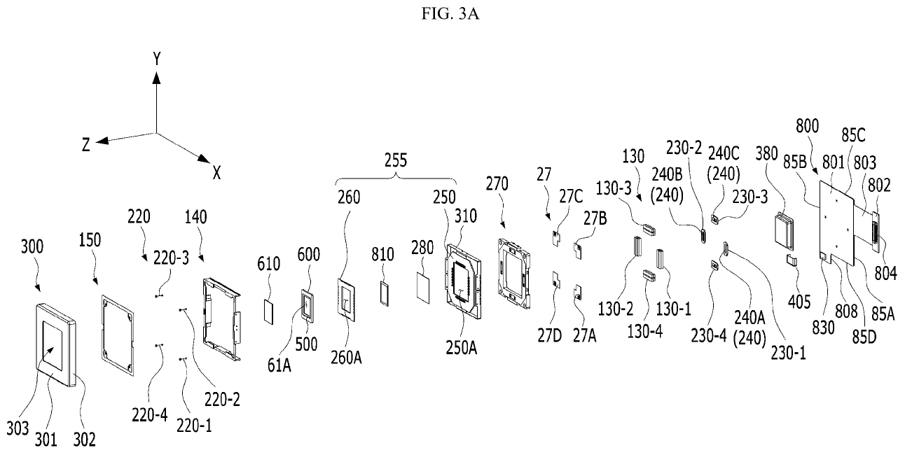

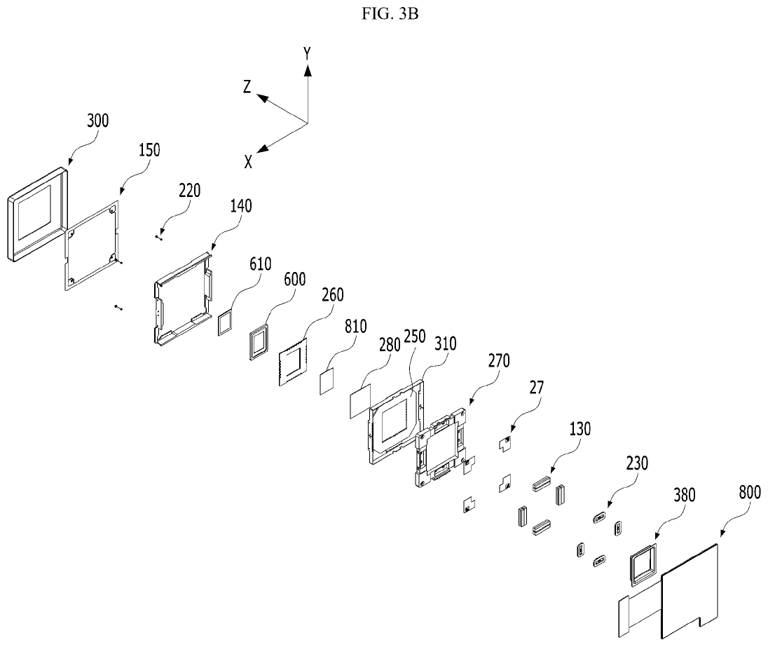

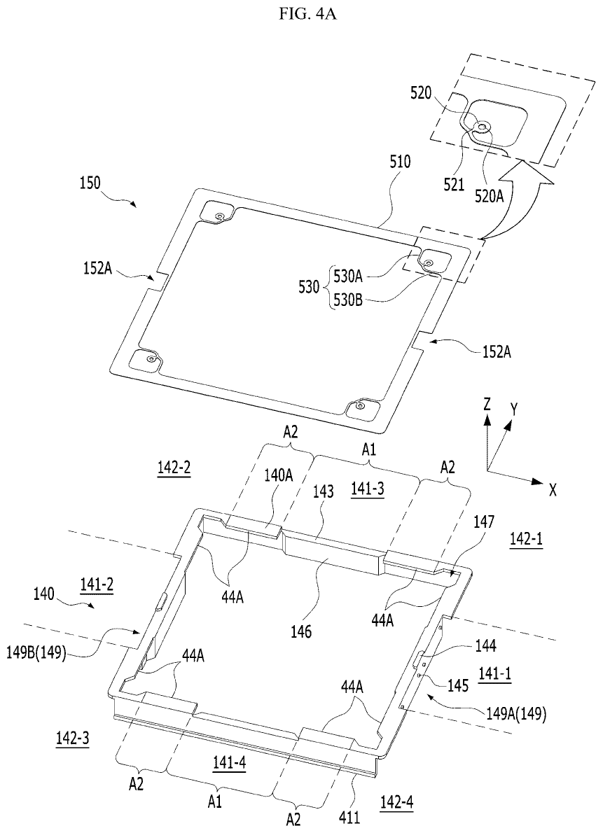

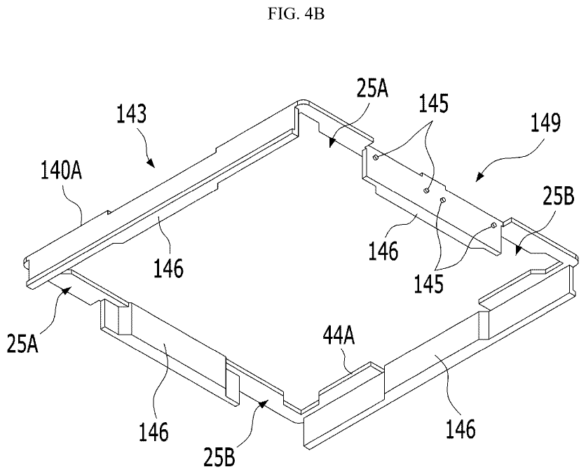

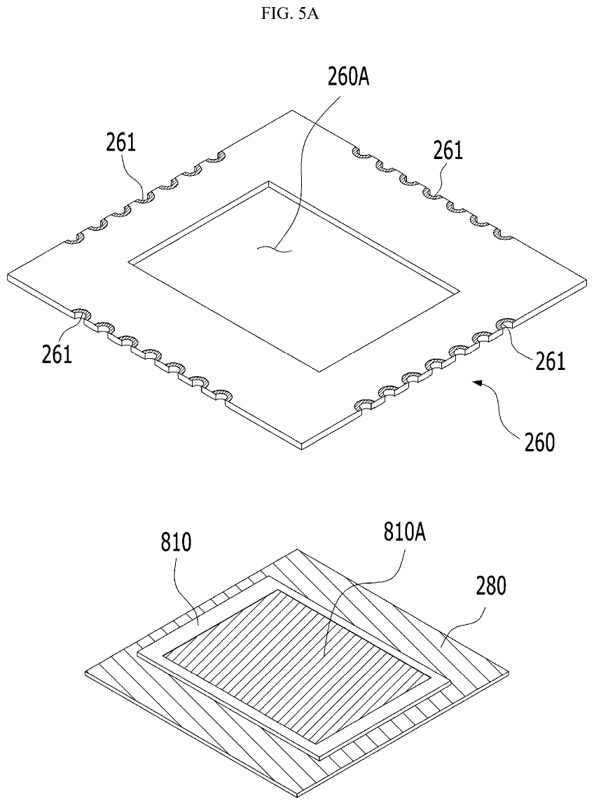

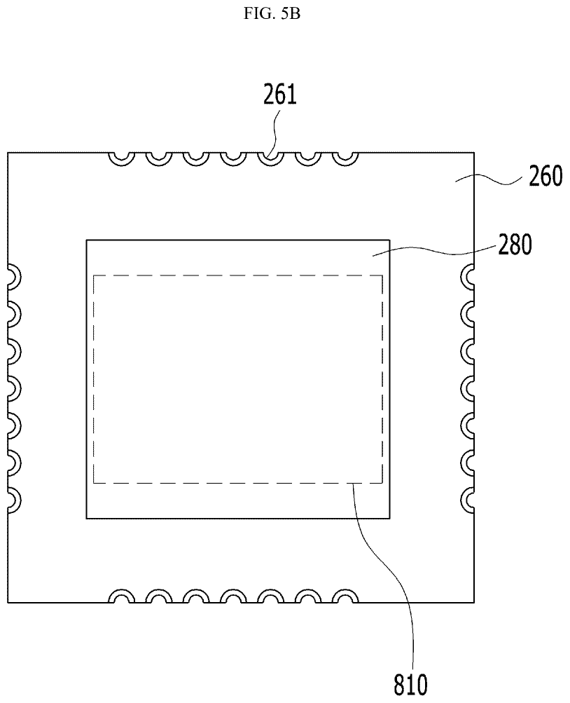

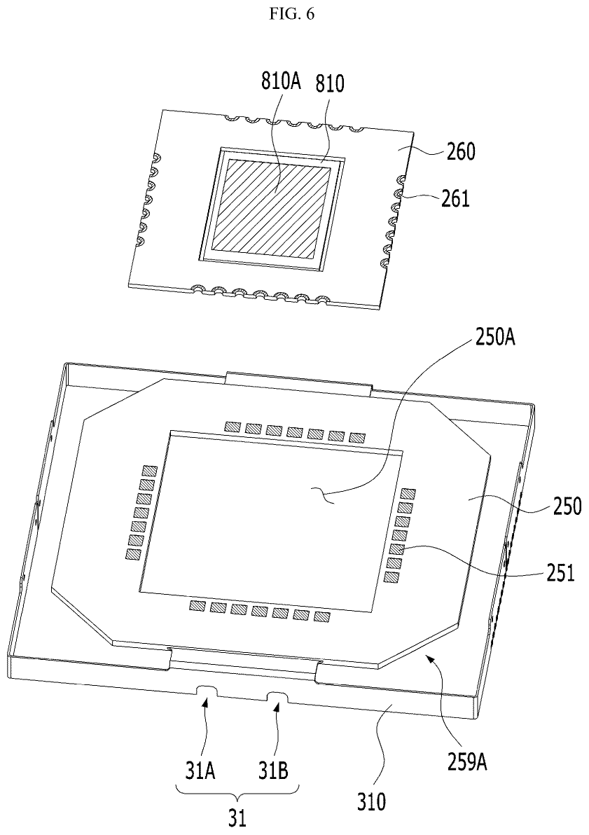

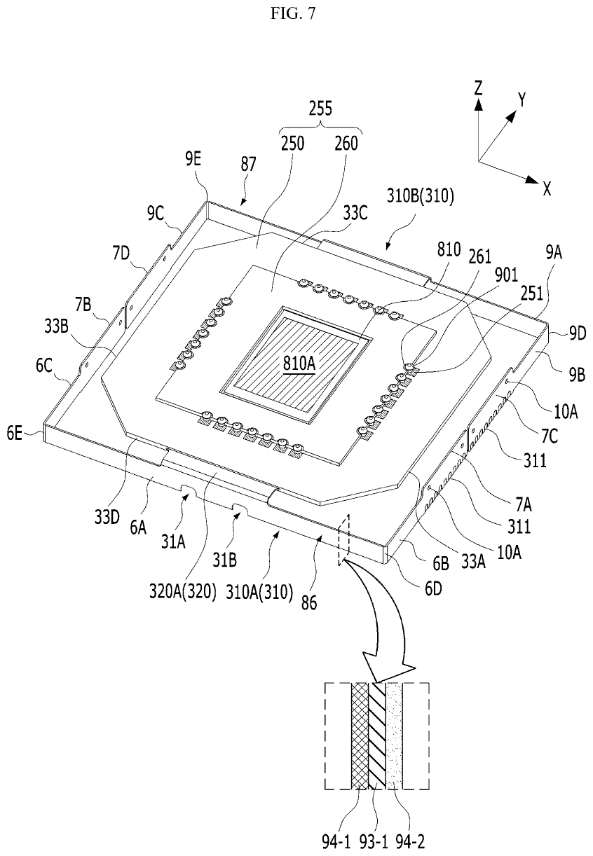

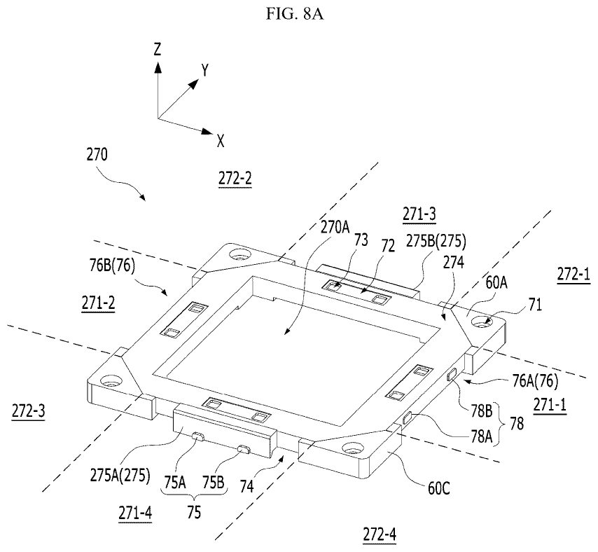

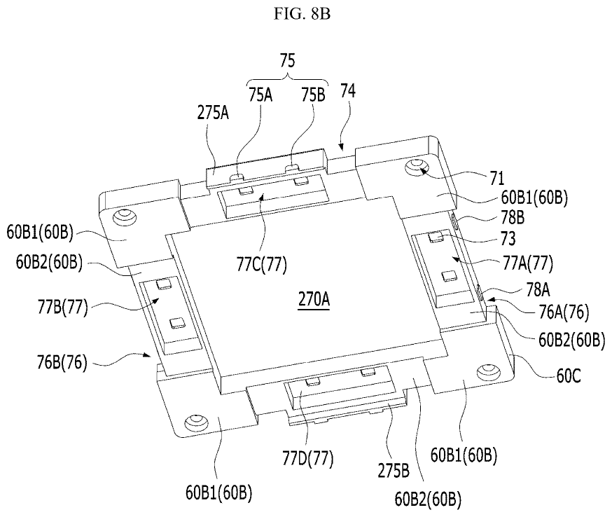

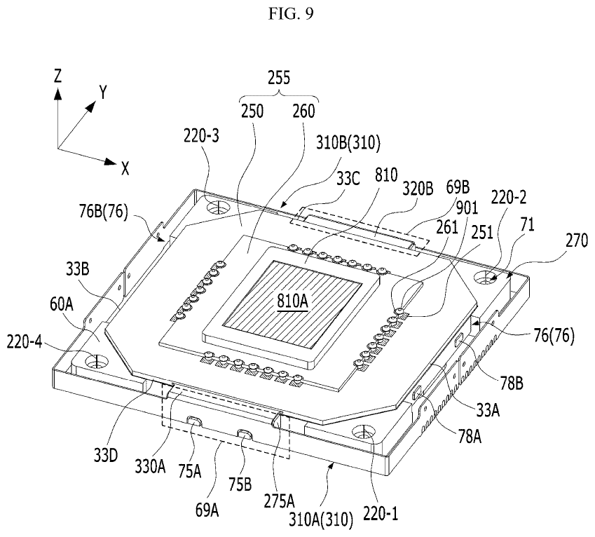

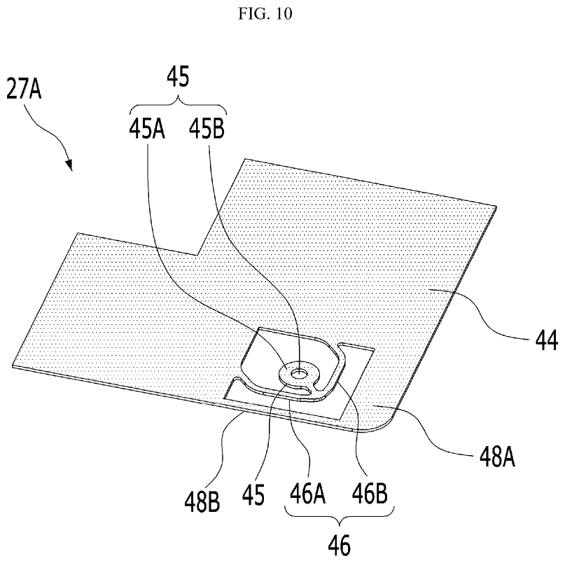

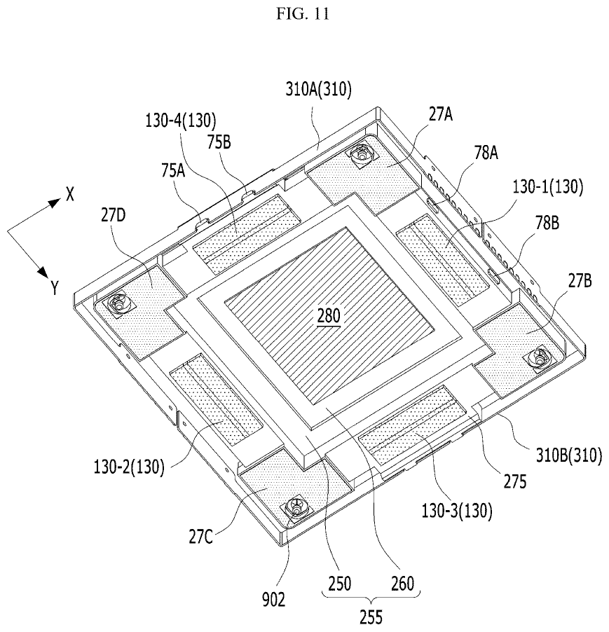

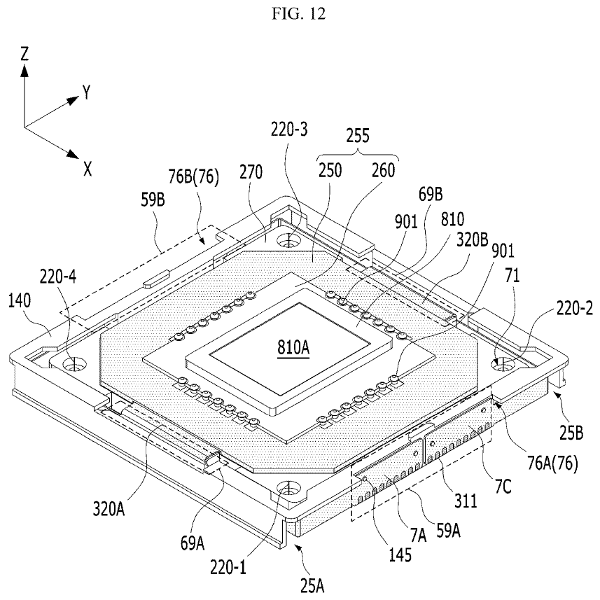

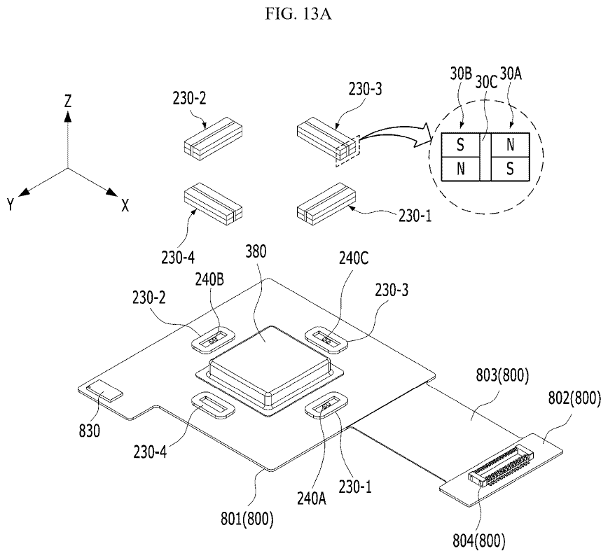

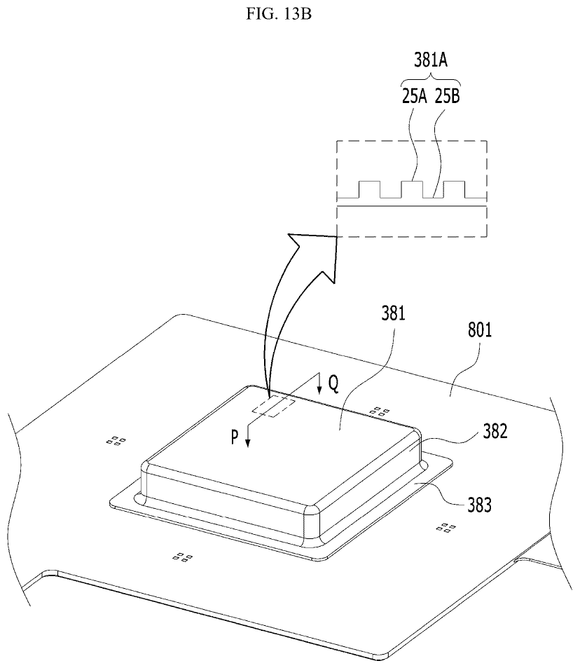

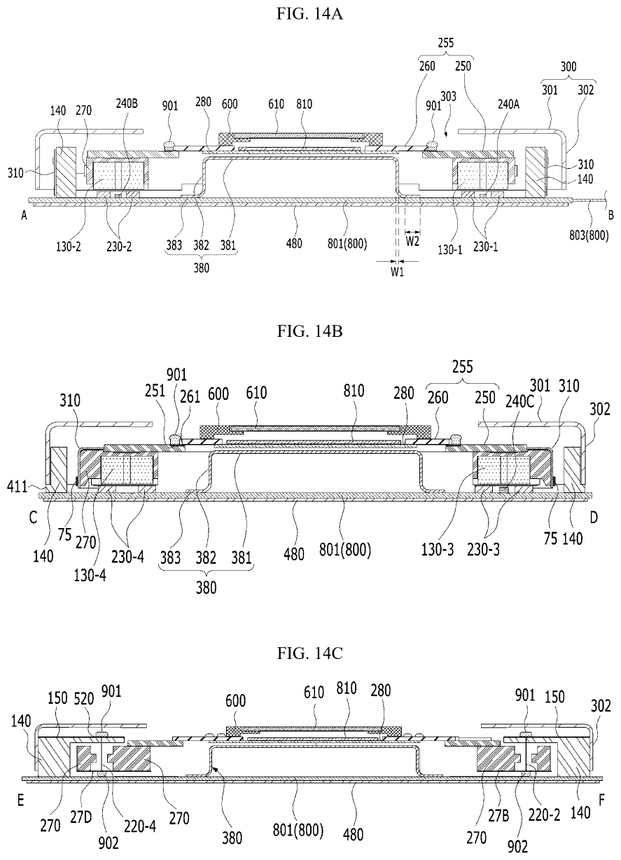

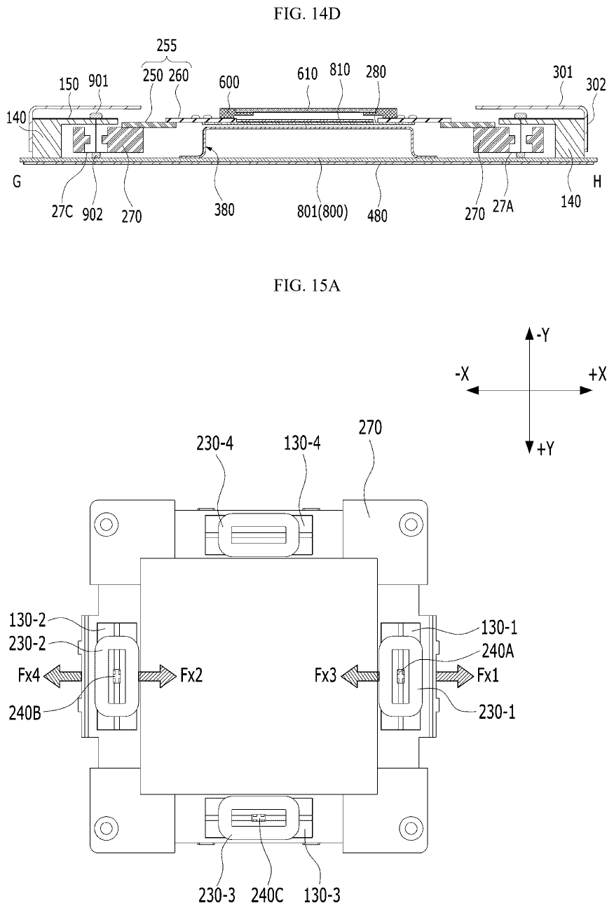

FIG. 1 is a perspective view of a camera device 10 according to an embodiment, FIG. 2 is a perspective view of a camera device 10 with the cover member 300 removed, FIG. 3A is a first separated perspective view of the camera device 10 in FIG. 1. FIG. 3B is a second separated perspective view of the camera device 10 of FIG. 1, FIG. 4A is a perspective view of the first elastic member 150 and the housing 140, FIG. 4B is a bottom perspective view of the housing, FIG. 5A is a separated perspective view of the second circuit board 250, the image sensor 810, and the heat dissipation member 280, FIG. 5B is a rear assembled perspective view of the second circuit board 250, the image sensor 810, and the heat dissipation member 280, FIG. 6 is a separated perspective view of the second circuit board 250 to which the image sensor 810 and the heat dissipation member 260 are coupled and the circuit board 250 to which the support board 310 is coupled, FIG. 7 is an assembled perspective view of the circuit board 260 and the circuit board 250 of FIG. 6, FIG. 8A is a first perspective view of the holder 270, FIG. 8B is a second perspective view of the holder 270, FIG. 9 is a perspective view of the first substrate member 255 of FIG. 7 coupled to the holder 270, FIG. 10 is a perspective view of the first elastic unit 27A of the third elastic member 27, FIG. 11 is a perspective view of the third elastic member 27 and the magnet 130 coupled to the holder 270 of FIG. 7, FIG. 12 is an assembled perspective view of the support board 310 and the housing 140 of FIG. 11, FIG. 13A is a perspective view of the second substrate member 800, the magnet 130, the coil 230, and the heat dissipation member 380, FIG. 13B shows an embodiment of the heat dissipation member 380, FIG. 14A is a cross-sectional view in the AB direction of FIG. 1, FIG. 14B is a cross-sectional view in the CD direction of FIG. 1, FIG. 14C is a cross-sectional view in the EF direction of FIG. 1, FIG. 14D is a cross-sectional view in the GH direction of FIG. 1.

The camera device 10 may include a moving unit including an image sensor 810 and a driving unit that moves the moving unit in a direction perpendicular to the optical axis OA. In addition, the camera device 10 may include a stationary unit and a support member connecting the moving unit and the stationary unit.

In addition, the camera device 10 may tilt, rotate, or roll the moving unit (e.g., the image sensor 810) with respect to the optical axis or with the optical axis as a rotation axis. By the camera device 10, a shake correction function of the camera device 200 can be performed.

The image sensor 810 may include an imaging area 810A, (see FIG. 5A) for detecting light passing through the lens module of the camera device. Here, the imaging area 810A may be expressed as an effective area, a light-receiving area, an active area, or a pixel area. For example, the imaging area 810A of the image sensor 810 is a region where light passing through the filter 610 is incident and an image included in the light is formed, and the imaging area 810A may include at least one unit pixel. For example, the imaging area 810A may include a plurality of unit pixels.

The camera device 10 may be expressed as an “image sensor moving device” or an “image sensor shift device”, a “sensor moving unit”, or a “sensor shift unit”.

The stationary unit may be a part that does not move when OIS operation is performed, and the moving unit may be a part that moves when OIS operation is performed. For example, the stationary unit may include a cover member 300, a housing 140, a component coupled to the housing 140 (e.g., a second substrate member 800, and a component coupled to the second substrate member 800 (e.g., a coil 230, a heat dissipation member 380, and a position sensor 240).

For example, the moving unit may include a first substrate member 250 and 260, a component coupled to the first substrate member 250 and 260 (e.g., the image sensor 810, the heat dissipation member 280, the filter holder 600, the filter 610), the holder 270, and a component coupled to the holder 270 (e.g., the magnet 130, the third elastic member 27). The term substrate member 255 or 800 may also be expressed as a “board” or a “circuit board.”

FIG. 4A and Referring to FIG. 4B, the housing 140 is disposed inside the cover member 300. For example, the housing 140 may be disposed on the second substrate member 800. The housing 140 may accommodate the moving unit inside and may be coupled with the support board 310. The housing 140 may be coupled with the second substrate member 800. For example, the lower part, the lower surface, or the bottom of the housing 140 may be coupled to the upper surface of the second substrate member 800 by an adhesive. A camera device according to another embodiment may further include a base disposed between the housing 140 and the second substrate member 800, and an upper part or an upper surface of the base may be coupled with the housing 140, and a lower part or a lower surface of the base may be coupled with the second substrate member 800.

The housing 140 may have a hollow column shape as a whole. For example, the housing 140 may have a polygonal (e.g., square or octagonal) or circular opening, and the opening of the housing 140 may be a through hole shape penetrating the housing 140 in the optical axis direction.

The housing 140 may include side portions 141-1 to 141-4 corresponding to or facing the side plate 302 of the cover member 300 and corners 142-1 to 142-4 corresponding to or facing the corners of the cover member 300.

In order to prevent direct collision with the inner surface of the upper plate 301 of the cover member 300, the housing 140 may include a stopper (not shown) protruding from the upper portion, upper surface 140A, or upper end thereof.

The housing 140 may include a first coupling portion for coupling with the first elastic member 150. In FIG. 4A, the first coupling portion is in a flat shape, but in other embodiments, the first coupling portion may be in a protrusion or groove shape. The first elastic member 150 may include a through hole or groove for coupling with the first coupling portion of the housing 140. For example, the first coupling portion of the housing 140 and a through hole of the first elastic member 150 may be coupled by heat staking or adhesive.

The housing 140 may include a guide protrusion 144 protruding from the upper surface 140A thereof. The guide protrusion 144 may serve to guide a position of the first elastic member 150 when the first elastic member 150 is coupled to the housing 140. For example, the first elastic member 150 may include a groove 152A corresponding to the guide protrusion.

The housing 140 may include an escape portion 147 to avoid spatial interference with the second elastic member 220. For example, the escape portion 147 may be disposed at a corner portion 142-1 to 142-4 of the housing 140 or formed at a corner portion 142-1 to 142-4. For example, the escape portion 147 may be in the form of a hole, a through hole, or a groove passing through the housing 140 in the optical axis direction.

For example, the escape portion 147 may include an opening that opens to the inside of the housing 140. In another embodiment, the escape portion 147 may include an opening that opens to the outside or outer surface of the housing 140. In another embodiment, the escape portion 147 may have a structure that is recessed from the outer surface of the corner portion of the housing 140, and at least a portion of the escape portion may be opened to the outer surface of the corner portion. The number of escape portions 147 of the housing 140 may be equal to the number of second elastic members 220.

A seating portion 149 may be formed at at least one side portion of the housing 140 for coupling at least a portion of the support board 310.

For example, the seating portion 149 may be in the form of a groove. For example, a first seating portion 149A to which a terminal portion (e.g., 7A, 7C) of the support board 310 is coupled may be formed at the first side portion 141-1 of the housing 140, and a second seating portion 149B to which a terminal portion (e.g., 7B, 7D) of the support board 310 is coupled may be formed at the second side portion 141-2 of the housing 140. For example, the seating portion 149 may be a groove that is recessed from an outer surface of the side portion 141-1, 141-2 of the housing 140. In another embodiment, the seating portion 149 may be omitted, and the support board 310 may be coupled with the outer surface of the side portion of the housing 140.

The housing 140 may include at least one protrusion 145 that is coupled with the support board 310. For example, at least one protrusion 145 may be formed at the first side portion 141-1, 141-2 and the second side portion 141-2 of the housing 140. For example, at least one protrusion 145 may be disposed in the seating portion 149. For example, at least one protrusion 145 may protrude from a bottom surface of the seating portion 149. For example, a plurality of protrusions 145 may be formed at the seating portion 149. The support board 310 may include a hole 10A (see FIG. 7) for coupling with at least one protrusion of the housing 140. For example, the hole 10A may be formed at the terminal portion 7A to 7D of the support board 310.

For example, the housing 140 may include a protruding portion 146 protruding from the inner surface of at least one of the side portions 141-1 to 141-4. For example, the housing 140 may include a protruding portion 146 corresponding to or positioned opposite to the seating portion 149. A thickness of the side portions 141-1, 141-2 of the housing 140 may be reduced due to forming the seating portion 149, but in an embodiment, the rigidity of the housing 140 can be prevented from being weakened by forming the protrusion portion 146. The protruding portion 146 may be formed at the third and fourth side portions 141-3, 141-4 of the housing 140, and in other embodiments, the protruding portions 146 may be omitted at the third and fourth side portions 141-3, 141-4.

The housing 140 may include a protruding portion 44A (or an extending portion) that protrudes or extends from the upper portion, upper end, or upper surface of at least one of the side portions 141-1 to 141-4 of the housing 140 based on the inner surface of the side portions 141-1 to 141-4.

For example, the protruding portions 44A may extend or protrude in a direction perpendicular to the optical axis, for example, in the second direction (X-axis direction) or the third direction (Y-axis direction) from the upper portion, upper end, or upper surface of each of the side portions 141-1 to 141-4 of the housing 140.

Referring to FIG. 12 and FIG. 14A to FIG. 14D, the protruding portion 44A of the housing 140 may be located on the upper side of the support board 310 (body). For example, the protruding portion 44A of the housing 140 may correspond to, face, or overlap the support board 310 (body) in the optical axis direction. The protruding portion 44A may protect the support board 310 from impact and prevent foreign substances from falling onto the support board 310.

In order to avoid spatial interference with the connecting portion 320; 320A, 320B of the support board 310, the protruding portion 44A may not be formed at the first area A1 (see FIG. 4A) of the side portion 141-3, 141-4 of the housing 140 corresponding to, facing, or overlapping the connecting portion 320; 320A, 320B of the support board 310.

For example, an upper surface 143 of the first region A1 of the side portion 141-3, 141-4 of the housing 140 may be positioned lower than the upper surface 140A of the second region A2 of the side portion 141-3, 141-4 of the housing 140 excluding the first region A1. For example, there may be a step between the upper surface 143 of the first region A1 and the upper surface 140A of the second region A2 in the optical axis direction. For example, the upper surface 143 of the protruding portion 146 formed on the inner surface of the side portion 141-3, 141-4 of the housing 140 may be positioned lower than the upper surface 140A of the housing 140.

Referring to FIG. 4B, in order to avoid spatial interference with the holder 270 when the OIS operation is performed, an opening 25A, 25B may be formed at at least one of the side portions 141-1 to 141-4 of the housing 140. The opening 25A, 25B may be a through hole penetrating the side portion of the housing 140. The opening 25A, 25B may be formed at at least one of one side or another side of the seating portion 149 of the housing 140. In FIGS. 4A and 4B, the first opening 25A may be formed at one side of the seating portion 149 of each of the third and fourth side portions 141-3, 141-4 of the housing 140, and the second opening 25B may be formed at one side of the seating portion 149 of each of the third and fourth side portions 141-3, 141-4 of the housing 140. In another embodiment, the openings may be formed at the first and second side portions (14-1, 141-2) of the housing 140.

The housing 140 may be coupled with the cover member 300. For example, the housing 140 may be coupled with the side plate 302 of the cover member 300. For example, at least one of the side portions 141-1 to 141-4 of the housing 140 and/or at least one of the corner portions 142-1 to 142-4 may be formed with a step 411 that is coupled with the side plate 302 of the cover member 300. For example, the step 411 may protrude from a lower portion or a lower end of the outer surface of the housing 140.

An adhesive may be applied to the step 411 for coupling with the side plate 302 of the cover member 300, and the step 411 may serve to guide the side plate 302 when the side plate 302 is coupled with the step 411. For example, the step 411 of the housing 140 and the lower end of the side plate 302 of the cover member 300 may be bonded or coupled by an adhesive.

The camera device 10 may include an “elastic member” coupled with the stationary unit and the moving unit. The elastic member may support the moving unit with respect to the stationary unit. The elastic member may include a first elastic member 150 coupled with the stationary unit. The elastic member may include a second elastic member 220 coupled with the first elastic member 150. For example, the second elastic member 220 may be coupled with the moving unit. The elastic member may include a third elastic member 27 coupled with the moving unit and coupled with the second elastic member 220.

Referring to FIGS. 2 and 4A, for example, the first elastic member 150 may be coupled with the housing 140. For example, the first elastic member 150 may be coupled with the upper portion, the upper end, or the upper surface of the housing 140. For example, the first elastic member 150 may include a plate spring. For example, the first elastic member 150 may include an elastic material, for example, a metal material. For example, the first elastic member 150 may include a conductive material.

For example, the first elastic member 150 may include a first coupling portion 510 coupled with the housing 140, a second coupling portion 520 coupled with the second elastic member 220, and a connection portion 530 connecting the first coupling portion 510 and the second coupling portion 520. For example, the first coupling portion 510 may be coupled with the upper portion, the upper end, or the upper surface of the housing 140. For example, the first coupling portion 510 of the first elastic member 150 may be coupled with a first coupling portion of the housing 140. The first coupling portion 510 of the first elastic member 150 may include a through hole or a hole for coupling with the first coupling portion of the housing 140.

The second coupling portion 520 may include a through hole 520A or a hole for being connected with the second elastic member 220. For example, the second coupling portion 520 may be connected to the second elastic member 220 by a conductive adhesive or solder 905 (see FIG. 2). For example, the connection portion 530 may include a bent portion that is bent at least once or a curved portion that is bent at least once, but is not limited thereto, and in another embodiment, may be in a straight shape. For example, the connection portion 530 may include a first connection portion 530A that connects a portion (or a first region) of the first coupling portion 510 and the second connecting portion 520, and a second connection portion 530A that connects another portion (or a second region) of the first connection portion 510 and the second connection portion 520.

For example, the number of second coupling portion 520 may be equal to the number of second elastic member 220. For example, the first elastic member 150 may include one or more second coupling portions 510 corresponding to a single corner portion of the housing 140.

In another embodiment, the number of the connection portion connected to a single second coupling portion 520 may be one. In another embodiment, the number of the connection portion connected to the single second coupling member 520 may be three or more. For example, the second coupling portion 520 may be disposed to correspond to or face a corner portion of the housing 140 and may be spaced apart from the housing 140.

For example, a width of the connection portion 530 (530A or 530B) may be smaller than a width of the first coupling portion 510. In other embodiments, a width of the connection portion 530 (530A or 530B) and a width of the first coupling portion 510 may be equal to each other. For example, a width of the connection portion 530 (530A or 530B) may be smaller than a width or diameter of the second coupling portion 520.

For example, a portion 521 where the second coupling portion 520 and the connection portion 530 are coupled to each other may be positioned further inside than the hole 520A of the second coupling portion 520 with respect to the optical axis OA. For example, a first separation distance between the portion 521 and the optical axis OA may be smaller than a second separation distance between the hole 520A of the second coupling portion 520 and the optical axis OA. In other embodiments, the first separation distance may be larger than or equal to the second separation distance.

In FIG. 4A, the first elastic member 150 includes one elastic unit or a single elastic unit, but in other embodiments, the first elastic member 150 may include a plurality of elastic units that are spaced apart from each other.

The cover member 300 may accommodate the moving unit and the support board 310.

Referring to FIG. 3A, the cover member 300 may be a box-shaped body having an open bottom. The cover member 300 includes an upper plate 301 and a side plate 302. For example, a lower portion of the side plate 302 of the cover member 300 may be coupled with the housing 140. In another embodiment, the cover member 300 may be coupled with the second substrate member 800.

A shape of the upper plate 301 of the cover member 300 may be a polygon, for example, a square or an octagon. For example, the side plate 302 may include four side plates that are connected to each other. An opening 303 may be formed in the upper plate 301 of the cover member 300 to correspond to, face, or overlap with the image sensor 810 or the filter 610.

For example, the cover member 300 may be formed of a metal material. For example, the cover member 300 may be formed of SUS (Steel Use Stainless) (e.g., SUS 4 series). In addition, the cover member 300 may be formed of a cold rolled steel plate (Steel Plate Cold Commercial, SPC). For example, the cover member 300 may be formed of a SUS material containing 50 percent ([%)) or more of an iron component. In addition, for example, a surface of the cover member 300 may be plated with an anti-oxidation metal, such as nickel, to prevent oxidation. In addition, for example, in another embodiment, the cover member 300 may be formed of a magnetic material or a metal material having magnetism. In another embodiment, the cover member 300 may be formed of an injection molded product, such as a plastic or resin material. In addition, the cover member 300 may be made of an insulating material or a material that blocks electromagnetic waves.

At an initial position of the OIS moving unit, the OIS moving unit, for example, the holder 270 can be spaced apart from the housing 140. For example, at the initial position of the OIS moving unit, the OIS moving unit, for example, the holder 270 can be spaced apart from an inner surface of the housing 140 by a predetermined distance. Also, for example, at the initial position of the OIS moving unit, the OIS moving unit, for example, the holder 270 and the first substrate member 255 can be spaced apart from the second substrate member 800. For example, at the initial position of the OIS moving unit, the first substrate member 255 can be spaced apart from the second substrate member 800 and the heat dissipation member 380.

The initial position of the OIS moving unit may be the position of the OIS moving unit when no power or driving signal is applied to the coil 230 from the controller 820 or 780. In addition, the initial position of the OIS moving unit may be the position where the OIS moving unit is placed when gravity acts from the first substrate member 255 toward the second substrate member 800, or when gravity acts in the opposite direction, when no power or driving signal is applied to the coil 230.

The camera device 10 may include the second elastic member 220 coupled with the first elastic member 150. In addition, the camera device 10 may include the third elastic member 27 coupled with the holder 260.

At least one of the second elastic member 220 and the third elastic member 27 may elastically support the moving unit with respect to the stationary unit together with the first elastic member 150. The second elastic member 220 may be in the form of a wire or a spring. The second elastic member 220 may include a conductive material, for example, a metal material.

For example, one end of the second elastic member 220 may be coupled with the first elastic member 150. In another embodiment, the first elastic member 150 may be omitted, and the second elastic member 220 may be coupled with the housing 140. For example, the other end of the second elastic member 220 may be coupled with the third elastic member 27. In another embodiment, the third elastic member 27 may be omitted, and the other end of the second elastic member 220 may be coupled with the holder 270.

For example, at least a portion of the second elastic member 220 may pass through the escape portion 147 of the housing 140, and at least another portion of the second elastic member 220 may pass through a hole 71 of the holder 270. Also, for example, one end of the second elastic member 220 may be coupled to the second coupling portion 520 of the first elastic member 150 by solder 905 (see FIG. 2) or a conductive adhesive. For example, the other end of the second elastic member 220 may be coupled to the third elastic member 27 by solder 902 (see FIG. 11) or a conductive adhesive. The third elastic member 27 may be disposed on the holder 270 or coupled to the holder 270.

The second elastic member 220 may be disposed parallel to the optical axis direction. For example, the second elastic member 220 may be disposed at the corners 142-1 to 142-4 of the housing 140 or/and the corners of the holder 270. The second elastic member (220) may also be alternatively expressed as a “support member”.

For example, the second elastic member 220 may include a plurality of wires. For example, each of the four wires 220-1 to 220-4 may be disposed at a corresponding one of the four corners of the housing 140 or/and the four corners of the holder 270.

Referring to FIG. 11, the hole 71 may be formed in the holder 270 for passing a portion of the second elastic member 220. For example, the hole 71 may be formed at a corner of the holder 270 for the other end of the second elastic member 220 to pass through. For example, the hole 71 may be formed at each of the four corners of the holder 270. For example, the hole 71 may be a through hole penetrating the holder 270 in the optical axis direction, but in another embodiment, it may be in the form of a escape groove. In addition, referring to FIG. 8B, the hole 71 may include a portion, and a diameter of the portion of the hole 71 may increase in a direction from the upper surface 60A of the holder 270 toward the lower surface 60B of the holder 27. In another embodiment, the diameter of the hole 71 may be uniform.

The third elastic member 27 may be disposed on the holder 270 or coupled with the holder 270. The third elastic member 27 may be disposed on the lower surface of the holder 270 or coupled with the holder 270. For example, the third elastic member 27 may be coupled with the lower surface of the corner of the holder 270.

In another embodiment, the third elastic member 27 may be disposed or coupled to the upper surface of the holder 270, in which case the hole 71 of the holder 270 may be omitted. In another embodiment, a groove may be formed on the lower surface of the holder 270 for the third elastic member 27 to be disposed, inserted, or coupled. In another embodiment, at least one protrusion may be formed on the lower surface of the holder 270 for coupling with the third elastic member 27, and a hole (or through hole) may be formed on the third elastic member 270 for coupling with the protrusion of the holder 270.

For example, the third elastic member 27 may include a plate spring. For example, the third elastic member 27 may include a conductive material. For example, the third elastic member 27 may be alternatively expressed as a “terminal,” a “terminal member,” or a “conductive layer.” In another embodiment, at least a portion of the third elastic member 27 may be disposed inside the holder 270 by insert molding. The third elastic member 27 may be coupled to the holder 270 by an adhesive or heat staking.

The third elastic member 27 may include at least one elastic unit. For example, the third elastic member 27 may include a plurality of elastic units 27A to 27D spaced apart from each other. In another embodiment, the elastic units 27A to 27D may be connected to each other.

Referring to FIG. 10, the third elastic member 27 may include a first coupling portion 44 (or body) coupled with the holder 270. The third elastic member 270 may include a second coupling portion 45 coupled with the other end of the second elastic member 220 and a connection portion 46 connecting the first coupling portion 44 and the second coupling portion 45.

The second coupling portion 45 may include a coupling region 45A coupled with the second elastic member 220 by solder 902 or a conductive adhesive, and a hole 45B formed in the coupling region 45A. For example, the other end of the second elastic member 220 passing through the hole 45B may be coupled to a lower portion or a lower surface of the coupling region 45A by solder 902 or a conductive adhesive.

For example, the connection portion 46 may include a first connection portion 46A connecting one region of the first coupling portion 44 and the second coupling portion 45, and a second connection portion 46B connecting another region of the first connecting portion 44 and the second coupling portion 45.

For example, the connection portion 46 may include a bent portion that is bent at least once or a curved portion that is curved at least once. In another embodiment, the connection portion 46 may be in the form of a straight line. For example, the number of the second coupling portions 45 may be the equal to the number of the second elastic members 220. For example, the third elastic member 27 may include one or more second coupling portions 45 corresponding to a single corner of the holder 270.

In another embodiment, the number of connection portions connected to the single second coupling portion 45 may be one. In another embodiment, the number of connecting portions connected to the single second coupling portion 45 may be three or more.

For example, the second coupling portion 45 may be disposed at a position corresponding to, face, or overlapping with the hole 71 formed at a corner of the holder 270 in the optical axis direction. For example, the second coupling portion 45 may be positioned below the hole 71 of the holder 270. The second coupling portion 45 may be positioned spaced apart from the holder 270.

For example, a width of the connection portion 46 (46A or 46B) may be smaller than a width of the first coupling portion 44. In other embodiments, the width of the connection portion 46 (46A or 46B) and the width of the first coupling portion 44 may be equal to each other. For example, the width of the connection portion 46 (46A or 46B) may be smaller than a width or diameter of the second coupling portion 45.

For example, the portion 47 where the second coupling portion 45 and the connection portion 46 are coupled to each other may be positioned further outside than the hole 45B of the second coupling portion 45 respect to the optical axis OA. For example, a third separation distance between the portion 47 where the second coupling portion 45 and the connection portion 46 are coupled to each other and the optical axis OA may be greater than a fourth separation distance between the hole 45B of the second coupling portion 45 and the optical axis OA. In other embodiments, the third separation distance may be smaller than or equal to the fourth separation distance.

For example, the third elastic member 27 may include four elastic units 27A to 27D corresponding to four wires 220-1 to 220-4. Each of the elastic units 27A to 27D may be disposed at a corresponding one of the corners of the holder 270 and may be coupled to a corresponding one of the wires 220-1 to 220-4. The description of the first elastic unit 27A of FIG. 10 may be equally applied or analogically applied to the other elastic units 27B to 27D.

The camera device 10 may include a first damper (not shown) disposed between the hole 147 of the housing 140 and the second elastic member 220. For example, the first damper may be disposed in the hole 147 of the housing 140. For example, the first damper may be coupled, contacted, or attached to the hole 147 of the housing 140 and at least a portion of the second elastic member 220.

In addition, the camera device 10 may include a second damper (not shown) disposed between the hole 71 of the holder 270 and the second elastic member 220. For example, the second damper may be disposed in the hole 71 of the holder 270. Each of the first and second dampers may be a buffer material made of silicone or resin. The first and second dampers may serve to absorb or alleviate vibration of the moving unit when the OIS operation is performed, and vibration of the moving unit can be prevented or suppressed.

The holder may be disposed in the housing 140. For example, the holder 270 may be made of a non-conductive material. For example, the holder 270 may be made of an injection molded material that is easy to shape by an injection molding process. In addition, the holder 270 may be formed of an insulating material. In addition, for example, the holder 270 may be made of a resin or plastic material.

Referring to FIGS. 8A and 8B, the holder 270 may include an upper surface 60A, a lower surface 60B opposite to the upper surface 60A, and a side surface 60C, for example, an outer side surface connecting the upper surface and the lower surface. For example, the lower surface 60B of the holder 270 may face or be opposite the second substrate member 800.

The holder 270 may support the first substrate member 255. The holder 270 may be coupled with the first substrate member 266. For example, the first substrate member 255 may be disposed on the holder 270. For example, the upper portion, upper surface 60A, or upper end of the holder 270 may be coupled with the lower portion, lower surface, or lower end of the first substrate member 255. For example, the holder 270 may be coupled with the first substrate member 255 by an adhesive. In another embodiment, the first substrate member 255 may be disposed under the holder 270 and may be coupled with the lower portion, lower surface, or lower end of the holder 270.

The holder 270 may accommodate or support the magnet 130. The holder 270 may support the magnet 130 so that the magnet 130 is spaced apart from the first substrate member 255. For example, at least a portion of a holder 270 may be disposed between the magnet 130 and the first substrate member 255.

The holder 270 may include an opening 270A corresponding to a region of the first substrate member 255. For example, the opening 270A of the holder 270 may be a through hole penetrating the holder 270 in the optical axis direction. For example, the opening 270A of the holder 270 may correspond to, face, or overlap the image sensor 810 or the heat dissipation member 280 or 380 in the optical axis direction.

A shape of the opening 270A of the holder 270 as viewed from the top may be a polygonal shape, for example, a square, a circle, or an oval shape, but is not limited thereto, and may be implemented in various shapes.

For example, the opening 270A of the holder 270 may have a shape or size that exposes the image sensor 810, a portion of an upper surface of the first circuit board 250, a portion of an upper surface of the second circuit board 260, and the elements. For example, an area of the opening 270A of the holder 270 may be larger than an area of the image sensor 810 and may be larger than an area of an opening 250A of the first circuit board 250. An area of the opening 270A of the holder 270 may be smaller than an area of a lower surface of the first circuit board 250. The maximum length of the opening 270A of the holder 270 in a transverse direction may be smaller than the maximum length of the first circuit board 250 in a transverse direction. The maximum length of the opening 270A of the holder 270 in the longitudinal direction may be smaller than the maximum length of the first circuit board 250 in the longitudinal direction.

The holder 270 may include a side portion and a corner portion. For example, the holder 270 may include a plurality of side portions 271-1 to 271-4 and corner portions 272-1 to 272-4. For example, the holder 270 may include a first side portion 271-1, a second side portion 271-2 positioned opposite the first side portion, a third side portion 271-3 positioned between the first side portion 271-1 and the second side portion 271-2, and a fourth side portion 271-4 positioned between the first side portion 271-1 and the second side portion 271-2 and opposite the third side portion 271-3.

For example, the side portions 271-1 to 271-4 of the holder 270 may correspond to, face, or overlap the side portions 141-1 to 141-4 of the housing 140, and corner portions 272-1 to 272-4 of the holder 270 may correspond to, face, or overlap the corner portions 142-1 to 142-4 of the housing 140.

The holder 270 may include a mounting portion 274 formed on the upper surface 60A of the holder 270 to accommodate the first circuit board 250. The mounting portion 274 may be a groove that is recessed from the upper surface 60A of the holder 270. For example, the mounting portion 274 may include a bottom surface and a side wall, and the first circuit board 250 may be disposed on the bottom surface of the mounting portion 274. The first circuit board 250 may be coupled to the holder 270 (e.g., the bottom surface of the mounting portion 274) by an adhesive.

A shape of the mounting portion 274 as viewed from the top may be the same as or coincident with a shape of the first circuit board 250. For example, the shape of the mounting portion 274 as viewed from the top may be a circular, oval, polygonal, for example, a square or octagonal shape.

The holder 270 may include a hole 71 for inserting or passing at least a portion of the second elastic member 220. For example, at least one hole 71 may be formed at a corner portion 272-1 to 272-4 of the holder 270.

The holder 270 may include an opening 73 that exposes or opens at least a portion of the magnet 130. The opening 73 may be a hole penetrating the holder 270 in the optical axis direction. For example, the opening 73 may expose or open at least a portion of the upper surface of the magnet 130. The opening 73 may be an “adhesive injection hole” or “adhesive injection portion” for injecting an adhesive for bonding the magnet 130 to the holder 270. For example, the opening 73 may overlap the magnet 130 in the optical axis direction.

For example, at least one opening 73 may be formed at each of the side portions 271-1 to 271-4 of the holder 270. For example, two or more openings 73 may be formed at each of the side portions 271-1 to 271-4 of the holder 270. For example, the opening 73 may be disposed in the mounting portion 274. For example, the opening 73 may be formed at the bottom surface of the mounting portion 274. For example, the opening 73 may overlap the first circuit board 250 in the optical axis direction.

The holder 270 may include a groove 72 that is recessed from the upper surface thereof. The groove 72 may be disposed within the mounting portion 274 and may be formed around the opening 73. For example, the opening 73 may be formed at the bottom surface of the groove 72. For example, the groove 72 may be formed at at least one of the side portions 271-1 to 271-4 of the holder 270.

For example, a step may exist in the optical axis direction between the upper surface 60A of the holder 270, the bottom surface of the mounting portion 274, and a bottom surface of the groove 72. The bottom surface of the mounting portion 274 may be positioned lower than the upper surface 60A of the holder 270, and the bottom surface of the groove 72 may be positioned lower than the bottom surface of the mounting portion 274. The groove 72 may serve to prevent the adhesive from overflowing out of the holder 270 when the adhesive is injected into the opening 73, and may serve to accommodate the adhesive.

For example, the holder 270 may include a protruding portion 275 formed at a side surface 60C of the holder 270 to support at least a portion of the support board 310. For example, at least a portion of the connecting portion 320 of the support board 310 may be disposed on the protruding portion 275 and coupled with the protruding portion 275. In addition, a portion of the body 86 and 87 of the support board 310 that is connected to the connecting portion 320 may be disposed on the protruding portion 275 and coupled with the protruding portion 275.

Referring to FIGS. 7 and 9, for example, a first connecting portion 320A and a portion of the body 86 of the first support board 310A may be disposed on or coupled to the protruding portion 275 of the side portion 274-4 of the holder 270. For example, a second connecting portion 320A and a portion of the body 87 of the second support board 310B may be disposed on or coupled to the protruding portion 275 of the side portion 274-3 of the holder 270.

For example, the opening of the protruding portion 275 may be equal to the number of the connecting portions 320. For example, the protruding portion 275 may be disposed on each of the third side portion 271-3 and the fourth side portion 271-4 of the holder 270. For example, the first connecting portion 320A may be disposed on or coupled to the protruding portion 275 of the fourth side portion 271-4, and the second connecting portion 320B may be disposed on or coupled to the protruding portion 275 of the third side portion 271-3.

In another embodiment, the protruding portion 275 may be omitted, and the connecting portion 320 may be disposed on or coupled to the side portions 271-3 and 271-4 of the holder 270.

The holder 270 may include a recess 76 formed on the side portion of the holder 270, and the recess 76 may correspond to, face, or overlap the protruding portion 146 of the housing 140. The recess 76 may be formed to secure a distance between the holder 270 and the housing 140 for the OIS operation. That is, by forming a recess 76 in the holder 270, in the embodiment, a spatial interference between the holder 270 and the housing 140 can be suppressed when the OIS operation is performed.

The recess 76 may be concave in the same direction as a protruding direction of the protruding portion 146 of the housing 146 and the recess 76 may be recessed from the outer side surface 60C of the holder 270. For example, the holder 270 may include recesses 76A and 76B disposed on each of the first side portions 271-1, 271-2 of the holder 270. In other embodiments, the recess 76 may be omitted.

The holder 270 may include at least one stopper 75 and 78 formed on the outer side surface 60C. The stopper 75 and 78 may protrude in a direction perpendicular to the optical axis or in a direction perpendicular to the outer side surface 60C. The stopper 75 and 78 may also be expressed as a “protruding portion” or a “protrusion”. The stopper 75 and 78 may prevent the outer surface of the holder 270 from directly contacting or colliding with the housing 140 when the OIS operation is performed, and thereby may prevent damage to the holder 270. In addition, the stopper 75 and 78 may prevent the connecting portion 320 of the support board 310 from directly contacting or colliding with the housing 140 when the OIS operation is performed, and thereby may prevent damage to the body 86 and 87 and the connecting portion 320.

For example, the holder 270 may include a first stopper 75 disposed on a protruding portion 275 of the holder 270. For example, the first stopper 75 may include one or more stoppers protruding from a side surface of the protruding portion 275. For example, the first stopper 75 may include two or more stoppers spaced apart from each other.

Referring to FIG. 7, the support board 310 may include at least one escape portion 31 (31A and 31B) to avoid spatial interference with the first stopper 75 of the holder 270. For example, the escape portion 31 may be formed at the body 86 and 87 of the support board 310. The escape portion 31 may be in the form of a groove or hole penetrating the body 86 and 87 of the support board 310.

For example, the first stopper 75 may be inserted into or disposed in the escape portion 31 of the holder 270, or may pass through the escape portion 31. The first stopper 75 disposed in the escape portion 31 may protrude from the support board 310 in the direction in which the first stopper protrudes. For example, the first stopper 75 may protrude from the side surface of the body 86 and 87 of the support board 310. This is to prevent damage to the body 86 and 87 and the connecting portion 320 due to collision when the OIS operation is performed. In an embodiment in which the protruding portion 275 is omitted, the first stopper may protrude from the outer surface of the side portion 271-3 and 271-4 of the holder 270.

Additionally, for example, the holder 270 may include a second stopper 78 positioned within the recess 76 of the holder 270. For example, the second stopper 78 may protrude from the bottom surface of the recess 76. For example, a protruding length of the second stopper 78 may be less than a depth of the recess 76. In other embodiments, the protruding length of the second stopper 78 may be greater than or equal to the depth of the recess 76.

For example, the second stopper 78 may include one or more stoppers protruding from the bottom surface of the recess 76. For example, the second stopper 78 may include two or more stoppers spaced apart from each other. In an embodiment where the recess 76 is omitted, the second stopper may also protrude from the outer side surface of the side portions 271-1 and 271-2 of the holder 270.

The holder 270 may include a mounting portion 77 for placing, mounting, or receiving the magnet 130. The mounting portion 77 may include mounting portions 77A to 77D formed on the side portions 271-1 to 271-4 of the holder 270. For example, the mounting portion 77 may be a recess recessed from the lower surface 60B of the holder 270. For example, the holder 270 may include a recess (e.g., 77) formed on the lower surface 60B, and the magnet 130 may be disposed in the recess (e.g., 77) of the holder 270.

For example, a shape of the mounting portion 77 may be the same as or coincident with a shape of the magnet 130. For example, a depth of the mounting portion 77 in the optical axis direction may be smaller than or equal to a length of the magnet 130 in the optical axis direction. In another embodiment, the depth of the mounting portion 77 in the optical axis direction may be larger than the length of the magnet 130 in the optical axis direction.

For example, the opening 73 may be in communication with or connected to the mounting portion 77. For example, the opening 73 may penetrate the bottom surface of the mounting portion 77.

Or, for example, the holder 270 may include protruding portions protruding from the lower surface. For example, the holder 270 may include a body including an opening 270A and protruding portions protruding from a lower surface of the body. The protruding portions may be disposed at corners of the holder 270 (e.g., the body). For example, the mounting portion 77 may be disposed between the protruding portions of the body.

For example, the holder 270 may include a recess formed between the protruding portions, and the mounting portion 77 may be formed on the bottom surface 60B2 of the recess. For example, the recess of the holder 270 may include at least one of a first opening that opens to an inner side surface of the holder 270 and a second opening that opens from the outer side surface of the holder 270.

The lower surface 60B of the holder 270 may include a first surface 60B1 and a second surface 60B2 that has a step from the first surface 60B1 in the optical axis direction. The second surface 60B2 may be positioned lower than the first surface 60B1. For example, the first surface 60B1 may be disposed at the corners 272-1 to 272-4 of the holder 270, and the second surface 60B2 may be disposed at the side portions 271-1 to 271-4 of the holder 270.

For example, the mounting portion 77 may be formed on the second surface 60B2 of the lower surface 60B of the holder 270. This is to avoid spatial interference between the magnet 130 and the coil 230 in case that the length in the optical axis direction of the magnet 130 disposed in the mounting portion 77 increases.

In another embodiment, there may be no step between the first surface 60B1 and the second surface 60B2, and the second surface 60B2 may be positioned on the same plane as the first surface 60B1.

Referring to FIG. 11, the third elastic member 27 may be coupled with the corner portions 272-1 to 272-4 of the holder 27. For example, each of the elastic units 27A to 27D of the third elastic member 27 may be coupled with the lower surface 60B1 of a corresponding one of the corner portions 272-1 to 272-4 of the holder 27. In another embodiment, a groove may be formed at the corner portion of the holder 27 for arranging or coupling the elastic unit of the third elastic member. In another embodiment, the holder 27 may include at least one protrusion for coupling with the elastic unit of the third elastic member 27. The protrusion may be formed at the lower surface of the corner portion of the holder 27. In addition, the elastic unit of the third elastic member 27 may include a hole or a through hole for coupling with at least one protrusion of the holder 27.

The first substrate member 255 may include a first circuit board 250 and a second circuit board 260 that are conductively connected to each other.

The first substrate member 255 may be disposed on an upper portion or an upper surface of the holder 270. For example, the first substrate member 255 may be coupled to an upper side of the holder 270. For example, the first circuit board 250 may be disposed on or coupled on the holder 250. For example, the first circuit board 250 may be disposed on or coupled to the upper surface of the holder 270. For example, the lower surface of the first circuit board 250 may be coupled to or attached to the upper surface of the holder 270 or the mounting portion 274 by an adhesive. At this time, the lower surface of the first circuit board 250 may be a surface facing the second substrate member 800. The first circuit board 250 may be conductively connected to the image sensor 810.

The first circuit board 250 may be alternatively expressed as an “interposer board” or a “connection board”. In addition, the second circuit board 260 may be alternatively expressed as an “sensor board”, a “main board”, a “main circuit board”, a “sensor circuit board”, or a “moving circuit board”.

In all embodiments, the “second substrate member 800” may be alternatively expressed as an “second circuit board”, and the second circuit board 260 may be alternatively expressed as an “third circuit board”.

Also, in all embodiments, the reference numeral 250 may be expressed as one of the “first to third substrates (or the first to fourth circuit boards)”, the reference numeral 260 may be expressed as another of the “first to third substrates (or the first to fourth circuit boards)”, and the reference numeral 800 may be expressed as another of the “first to third substrates (or the first to fourth circuit boards)”.

In another embodiment, the heat dissipation member 280 may be included in the first substrate member 255.

Referring to FIG. 6, the first circuit board 250 may include an opening 250A. For example, the opening 250A may correspond to, face, or overlap the lens module 400 of the camera device 200 or the opening 303 of the cover member 300 in the optical axis direction. For example, the opening 250A may be a through hole or hollow penetrating the first circuit board 250 in the optical axis direction, and may be formed at a center of the first circuit board 250.

When viewed from the top, a shape of the first circuit board 250, for example, the outer peripheral shape, may be a polygon (for example, a square or an octagon), a circle, or an oval. In addition, when viewed from the top, a shape of the opening 250A of the first circuit board 250 may be a polygon (for example, a square) or a circle or an oval shape. For example, the opening 250A of the first circuit board 250 may overlap the image sensor 810 or/and the second circuit board 260 in the optical axis direction.

In addition, the first circuit board 250 may include at least one terminal 251 for being conductively connected to the second circuit board 260. The terminal 251 may be disposed on the upper surface of the first circuit board 250.

Here, the terminal 251 of the first circuit board 250 may be expressed as a “pad” or a “bonding portion” instead. The terminal 251 of the first circuit board 250 may be arranged or disposed on the upper surface of the first circuit board 250. For example, the upper surface of the first circuit board 250 may be an opposite surface of the lower surface of the first circuit board.

For example, the terminal 251 may be plural, and the plurality of terminals 251 may be disposed in a region between the opening 250A of the first circuit board 250 and one side of the upper surface of the first circuit board 250. For example, the plurality of terminals 251 may be arranged or disposed in a direction parallel to one side of the upper surface of the first circuit board 250. For example, the plurality of terminals 251 may be disposed to surround the opening 250A.

For example, the first circuit board 250 may include a escape portion 259A formed at the first circuit board 250 to avoid spatial interference with the second elastic member 220. For example, the escape portion 259A may be in the form of a corner of the first circuit board 250 being chamfered, but is not limited thereto. In another embodiment, the escape portion of the first circuit board 250 may be in the form of a groove or a through-hole through which a part of the second elastic member 220 passes.

Referring to FIGS. 5A, 5B, and 6, the second circuit board 260 may be disposed on the first circuit board 250. When viewed from the top, the second circuit board 260 may be in the form of a polygon (e.g., a quadrangle, a square, or a rectangle), but is not limited thereto, and in another embodiment, may be in the form of a circle or an oval.

For example, an area of a region within an outer periphery of the second circuit board 260 having a quadrangle shape may be larger than an area of the opening 250A of the first circuit board 250. For example, the upper side of the opening 250A of the first circuit board 250 may be shielded or closed by the second circuit board 260.

For example, when viewed from the top or the bottom, the outer surface (or edge) of the second circuit board 260 may be positioned between the outer side surface (or an edge of the upper surface) of the first circuit board 250 and the opening 250A of the first circuit board 250.

For example, the second circuit board 260 may include an opening 260A corresponding to an opening 250A of the first circuit board 250 and/or the image sensor 810. The opening 260A of the second circuit board 260 may be a hole or hollow penetrating the second circuit board 260 in the optical axis direction and may be formed in the center of the second circuit board 260.

For example, the opening 260A of the second circuit board 260 may open or expose the image sensor 810. For example, the image sensor 810 may be disposed within the opening 260A of the second circuit board 260 and may be conductively connected to the second circuit board 260. Although not shown in FIG. 6, for example, the image sensor 810 may be conductively connected to the second circuit board 260 by a wire.

In another embodiment, the opening 260A may not be formed in the second circuit board 260, and the image sensor 810 may be disposed on or coupled to the upper surface of the second circuit board 260.

In another embodiment, the heat dissipation member 280 may be omitted, and in an embodiment where the heat dissipation member 280 is omitted, the opening 260A may not be formed in the second circuit board 260, and the image sensor 810 may be disposed on the upper surface of the second circuit board 260. For example, in an embodiment where the heat dissipation member 280 is omitted, the image sensor 810 may be disposed on an upper surface of a single substrate in which the first circuit board and the second circuit board are integrally formed.

The second circuit board 260 may include at least one terminal 261 conductively connected to at least one terminal 251 of the first circuit board 250. For example, the number of terminals 261 of the second circuit board 260 may be plural.

For example, at least one terminal 261 of the second circuit board 260 may be formed on a side surface or outer side surface of the second circuit board 260 connecting the upper and lower surfaces of the second circuit board 260. The lower surface of the second circuit board 260 may be a surface facing the upper surface of the first circuit board 250, and the upper surface of the second circuit board 260 may be an opposite surface of the lower surface of the second circuit board 260. For example, the terminal 261 may include a groove shape that is recessed from the side surface of the second circuit board 260. Or, for example, the terminal 261 may be a semicircular or semi-elliptical via formed on the side surface of the second circuit board 260. In another embodiment, at least one terminal 261 of the second circuit board 260 conductively connected to the second terminal 251 of the first circuit board 250 may be formed at the lower surface of the second circuit board 260. In another embodiment, the terminal 261 of the second circuit board may be a through-hole formed between the opening 260A of the second circuit board 260 and the side surface of the second circuit board 260.

For example, the terminal 261 of the second circuit board 260 may be coupled to the terminal 251 of the first circuit board 250 by solder 901 (see FIG. 7) or a conductive adhesive material.

For example, at least one of the first and second circuit boards 250 and 260 may be a printed circuit board or FPCB. Additionally, at least one of the first and second circuit boards 250 and 260 may be an organic substrate or a ceramic substrate.

The heat dissipation member 280 may be disposed on or coupled to the first substrate member 255. For example, the heat dissipation member 280 may be disposed on or coupled to the second circuit board 260. For example, the heat dissipation member 280 may be disposed under the second circuit board 260. For example, the heat dissipation member 280 may be disposed under the opening 260A of the second circuit board 260.

For example, the heat dissipation member 280 may be coupled or fixed to the lower surface of the second circuit board 260. For example, at least a portion of the upper surface of the heat dissipation member 280 may be coupled or fixed to the lower surface of the second circuit board 260 by an adhesive.

In another embodiment, the heat dissipation member 280 may be included in the first substrate member 255, and the image sensor 810 may be disposed at the first substrate member 255.

For example, the opening 260A of the second circuit board 260 may open or expose at least a portion (e.g., a first region) of the heat dissipation member 280. The image sensor 810 may be positioned on, attached to, or coupled to at least the portion (e.g., the first region) of the heat dissipation member 280 exposed by the opening 260A of the second circuit board 260. For example, the image sensor 810 may be fixed, attached, or coupled to the heat dissipation member 280 by an adhesive. At least a portion of a second region of the heat dissipation member 280 excluding the first region may be coupled or attached to the second circuit board 260. For example, a first region of the upper surface of the heat dissipation member 280 may be exposed by the opening 260A, and the image sensor 810 may be disposed to, attached to, or coupled to the first region of the upper surface of the heat dissipation member 280 exposed by the opening 260A.

In another embodiment, the second circuit board 260 may include a groove formed on the lower surface thereof to receive or place the heat dissipation member 280.

In another embodiment, the second circuit board 260 may not have an opening 260A, and the heat dissipation member 280 may be fixed, attached, or coupled to the lower surface of the second circuit board 260. In another embodiment, the heat dissipation member 280 may be omitted.

For example, the heat dissipation member 280 may be a plate-shaped member having a predetermined thickness and hardness. In addition, the heat dissipation member 280 may enhance the heat dissipation effect of dissipating heat generated from the heat source of the first substrate member 255 to the outside. At this time, the heat source of the first substrate member 255 may include an electronic element (or circuit element) disposed on the first substrate member 255, for example, an image sensor 810. In an embodiment in which the controller is disposed on the first substrate member, the heat source of the first substrate member 255 may include the controller.

For example, the heat dissipation member 280 may include at least one of a metal material having high thermal conductivity and high heat dissipation efficiency, such as SUS, aluminum, nickel, phosphorus, bronze, or copper.

In addition, the heat dissipation member 280 may stably support the image sensor 810 and may act as a reinforcing material to prevent the image sensor 810 from being damaged by external impact or contact.

In another embodiment, the heat dissipation member 280 may be formed of a heat dissipation member having high thermal conductivity, such as a heat dissipation epoxy, a heat dissipation plastic (e.g., polyimide), or a heat dissipation synthetic resin. The term “heat dissipation member” may also be expressed as a plate, a plate member, a metal plate, a reinforcing material, or a stiffener.

In order to improve the heat dissipation effect, the heat dissipation member 280 may include a predetermined pattern including at least one groove or at least one unevenness. For example, a groove or an unevenness having a predetermined pattern may be formed on the lower surface of the heat dissipation member 280.

For example, the predetermined pattern may include a plurality of grooves formed at predetermined intervals. For example, the predetermined pattern may have a stripe shape. In another embodiment, the predetermined pattern may have a mesh shape or a mech shape. In another embodiment, the predetermined pattern may have a shape including dots spaced apart from each other. For example, a shape of the dots may be circular, oval, or polygonal (e.g., square).

In another embodiment, the predetermined pattern may be formed on at least one of the upper surface, the lower surface, or the outer side surface of the heat dissipation member 280. In another embodiment, the heat dissipation member may include holes or through holes instead of the grooves or the unevenness. The heat dissipation member 280 moves together with the OIS moving unit, so the heat dissipation member 280 can be separated from the stationary unit, for example, the second substrate member 800.

For example, an area of the heat dissipation member 280 can be larger than an area of the opening 260A of the second circuit board 260. For example, a lower side of the opening 260A of the second circuit board 260 can be shielded or blocked by the heat dissipation member 280.

For example, when viewed from the top or the bottom, the outer side surface (or side) of the heat dissipation member 280 can be located between the outer side surface (or side of the lower surface) of the second circuit board 260 and the opening 260A of the second circuit board 260.

In FIG. 7, the first circuit board 250 and the second circuit board 260 are conductively connected to each other by solder 901, but in other embodiments, the first circuit board and the second circuit board may be implemented as a single integrated circuit board.

The magnet 130 may be disposed on, connected with, or fixed to the holder 270, which is a moving unit.

For example, referring to FIG. 14A, the magnet 130 may be disposed between the first circuit board 250 and the second substrate member 800. For example, at least a portion of the magnet (130) may be disposed between the first circuit board 250 and the second substrate member 800.

For example, the image sensor 810 may be positioned higher than the magnet 130. In addition, the image sensor 810 may be positioned higher than the driving unit that moves the moving unit. For example, the driving unit may include the magnet 130 and the coil 230.

For example, the magnet 130 may be positioned between the image sensor 810 and the second substrate member 800. For example, the magnet 130 may be positioned higher than the second substrate member 800 and lower than the image sensor 810.

For example, the magnet 130 may be disposed on, coupled to, or fixed to the side portion 271-1 to 271-4 of the holder 270. For example, the magnet 130 may be disposed within the mounting portion 77 of the holder 270. The magnet 130 may be a driving magnet for the OIS operation.

The magnet 130 may include a plurality of magnet units 130-1 to 130-4. In another embodiment, the magnet 130 may be disposed on the corner portions 272-1 to 272-4 of the holder 270.

The magnet 130 may be disposed on at least one of the side portion or the corner portion of the holder 270. For example, at least a portion of the magnet 130 may be disposed on the side portion or the corner portion of the housing 140. Or, for example, at least a portion of the magnet 130 may be disposed on the side portion of the housing 140 and the remaining portion of the magnet 130 may be disposed on the corner portion of the housing 140.

In another embodiment, the magnet unit may be disposed at a corresponding one of the corner portions of the holder 270 and a side portion adjacent to the corresponding one of the corner portions of the holder 270. For example, at least a portion of the magnet unit may be disposed at a corner portion of the holder 270 and the remaining portion of the magnet unit may be disposed at a side portion of the holder 270. In another embodiment, each of the magnet units may be disposed at a corresponding one of the side portions of the holder 270 and may be disposed close to a corresponding one of the corner portions of the holder 270.

For example, the magnet 130 may include first to fourth magnet units 130-1 to 130-4. In another embodiment, the magnet 130 may include two or more magnet units.

For example, the first magnet unit 130-1 and the second magnet unit 130-2 may be disposed on opposite sides of the holder 270 in a first horizontal direction (e.g., in the X-axis direction). For example, the third magnet unit 130-3 and the fourth magnet unit 130-4 may be disposed on opposite sides of the holder 270 in a second horizontal direction (e.g., in the Y-axis direction).

For example, the first magnet unit 130-1 and the second magnet unit 130-2 may be disposed parallel to each other in the second horizontal direction, and the third magnet unit 130-3 and the fourth magnet unit 130-4 may be positioned parallel to each other in the first horizontal direction.

Referring to FIG. 13A, the magnet unit of the magnet 130 may include a bipolar magnet or a quadrupolar magnet including two N-pole regions and two S-pole regions. For example, the magnet 130 may include a first magnet portion 30A, a second magnet portion 30B, and a partition wall 30C disposed between the first magnet portion 30A and the second magnet portion 30B. At this time, the partition wall 30C may be a non-magnetic material, air, or the like, and the partition wall may be expressed as a “neutral zone” or a “neutral region.” In another embodiment, the second magnet 71B may be a bipolar magnet including one N-pole region and one S-pole region.

For example, the first magnet portion 30A and the second magnet portion 30B may be spaced apart from each other in a direction perpendicular to the first direction (or the optical axis direction). For example, the first magnet portion 30A may include a first N pole region and a first S pole region that are opposite to each other or face each other in the optical axis direction. The second magnet portion 30B may include a second N pole region and a second S pole region that are opposite to each other or face each other in the optical axis direction. In addition, the first N pole region (or the first S pole region) of the first magnet portion 30A and the second S pole region (or the second N pole region) of the second magnet portion 30B may be opposite to each other or face each other in a direction perpendicular to the optical axis. For example, the partition wall 30C may be formed parallel to the optical axis direction.

In another embodiment, the magnet 130 may include a unipolar magnet or a bipolar magnet including one N-pole region and one S-pole region.

For example, the magnet units 130-1 to 130-4 may have the same size and shape. For example, two magnet units 130-1 and 130-2 positioned opposite each other may have the same size and shape, and the remaining two magnet units 130-3 and 130-4 positioned opposite each other may have the same size and shape.

The second substrate member 800 may be disposed under the first substrate member 255. The second substrate member 800 may be disposed under the housing 140 (or the cover member 300).

For example, the second substrate member 800 may be disposed apart from the moving unit, for example, the first substrate member 255 and the heat dissipation member 280 in the optical axis direction.

For example, the second substrate member 800 may be coupled to the housing 140. For example, the second substrate member 800 may be coupled to the lower end, the lower portion, or the lower surface of the housing 140.

The second substrate member 800 may serve to provide a signal from the outside to the image sensor 810 or output a signal transmitted from the image sensor 810 to the outside.

The second substrate member 800 may include a first region 801 (or first substrate) corresponding to, facing, or overlapping with the image sensor 810 or the lens module 400 of the camera device 200 in the optical axis direction, a second region 802 (or second substrate) in which a connector 804 is disposed, and a third region 803 (or third substrate) connecting the first region 801 and the second region 802.

The connector 804 may be conductively connected to the second region 802 of the second substrate member 800 and may have a port for conductively connecting an external device (e.g., an optical device 200A).

The first region 801 of the second substrate member 800 may correspond to, face, or overlap at least one of the cover member 300, the first substrate member 255, or the image sensor 810 in the optical axis direction. For example, the first region 801 may overlap the upper plate 301 and the side plate 302 of the cover member 300 in the optical axis direction.

Each of the first region 801 and the second region 802 of the second substrate member 800 may include a rigid substrate. The third region 803 may include a flexible substrate. Additionally, each of the first region 801 and the third region 802 may further include a flexible substrate.

In another embodiment, at least one of the first to third regions 801 to 803 of the circuit board 800 may include at least one of a rigid substrate and a flexible substrate.

The second substrate member 800 may be disposed at a rear side of the first substrate member 255. For example, the first substrate member 255 may be disposed between the cover member 300 and the second substrate member 800. In another embodiment, the second substrate member may be disposed between the cover member 300 and the first substrate member.

When viewed from the top, the first region 801 of the second substrate member 800 may have a polygonal shape (e.g., a quadrilateral, a square, or a rectangle), but is not limited thereto, and in other embodiments, may have a circular shape, etc.

Referring to FIG. 3, the first region 801 may include four side portions 85A to 85D (or side surfaces). For example, the first region 801 may include first and second side portions 85A and 85B that are positioned facing or opposite to each other in a first horizontal direction (e.g., an X-axis direction), and third and fourth side portions 85C and 85D that are positioned facing or opposite to each other in a second horizontal direction (e.g., a Y-axis direction).

The second region 802 may be disposed adjacent to the first side portion 85A of the first region 801, and the third region 803 may be connected to the first side portion 85A of the first region 801. For example, the third region 803 may extend from the first region 801 and be connected to a side of the second region 802 that faces the first side portion 85A.

The second substrate member 800 may include a plurality of terminals (not shown) corresponding to the terminals 311 of the support board 310. The plurality of terminals may be formed in the first region 801 of the second substrate member 800. For example, the second substrate member 800 may include first terminals disposed to be spaced apart in the first horizontal direction along a side of the third side portion 85C and second terminals disposed to be spaced apart in the first horizontal direction along a side of the fourth side portion 85D of the first region 801.

For example, the controller 830 may be disposed on an extension region 808 extending from one of the third and fourth side portions 85C and 85D of the first region 801 of the second substrate member 800. In another embodiment, the controller may be disposed on an extension region extending from the first side portion 85A or the second side portion 85B of the first region 801 of the second substrate member 800.

The camera device 200 may further include a heat dissipation member 380 disposed on, coupled to, or fixed to the second substrate member 800. For example, the heat dissipation member 380 may be disposed between the image sensor 810 and the second substrate member 800. For example, the heat dissipation member 380 may be disposed on, coupled to, or fixed to the upper surface of the first region 801 of the second substrate member 800. In another embodiment, the heat dissipation member 380 may be omitted.

The camera device 200 may further include a third heat dissipation member 480 disposed on, coupled to, or fixed to the lower surface of the second substrate member 800 (see FIG. 14A, FIG. 14B).

The heat dissipation member 380 may include a first portion coupled to the second substrate member 800 and a second portion protruding from the first portion and positioned adjacent to the image sensor 810.

For example, the heat dissipation member 380 may be a plate-shaped member having a predetermined thickness and hardness. In addition, the heat dissipation member 380 may face or overlap the heat dissipation member 280 in the optical axis direction.

Referring to FIG. 13, the heat dissipation member 380 may be in the form of a protruding plate protruding from the upper surface of the second substrate member 800. For example, the heat dissipation member 380 may include a top plate 381 and a side plate 382 connected to the top plate.

The top plate 381 may correspond to, face, or overlap the first substrate member 255 or the heat dissipation member 280 in the optical axis direction. For example, the top plate 381 may be a flat plate perpendicular to the optical axis. The side plate 382 may be disposed between the top plate 381 and the second substrate member 800 and may be connected to the top plate 381. For example, the heat dissipation member 380 may include a plurality of side plates.

For example, a connection portion of the top plate 381 and the side plate 382 may be round or curved. Also, for example, the connection portion of the side plates may be rounded or curved.

The upper surface of the heat dissipation member 380 (for example, the upper surface of the top plate 381) may be positioned lower than the lower surface of the first circuit board 250. In another embodiment, the upper surface of the heat dissipation member 380 (e.g., the upper surface of the top plate 381 and the lower surface of the first circuit board 250 may have the same height. In another embodiment, the upper surface of the heat dissipation member 380 (e.g., the upper surface of the top plate 381) may be positioned higher than the lower surface of the first circuit board 250.

For example, the upper surface of the heat dissipation member 380 (the upper surface of the top plate 381) may be positioned lower than the upper surface of the first circuit board 250.

For example, the upper surface of the heat dissipation member 380 ((e.g., the upper surface of the top plate 381)) may be positioned higher than an upper surface of the coil 230 arranged on the second substrate member 800.

For example, the upper surface of the heat dissipation member 380 (e.g., the upper surface of the upper plate 381) may be positioned higher than the upper surface of the magnet 130 disposed on the holder 270. In another embodiment, the upper surface of the heat dissipation member 380 (for example, the upper surface of the upper plate 381) and the upper surface of the magnet 130 disposed on the holder 270 may have the same height based on the upper surface of the second substrate portion 800.

In another embodiment, for example, the upper surface of the heat dissipation member 380 (e.g., the upper surface of the top plate 381) may be positioned lower than the upper surface of the magnet 130 and higher than the lower surface of the magnet.

For example, the upper surface of the heat dissipation member 380 (e.g., the upper surface of the top plate 381) may be positioned lower than the upper surface of the holder 270 (e.g., 60A). In other embodiments, the upper surface of the heat dissipation member 380 (e.g., the upper surface of the top plate 381) may be positioned higher than the upper surface of the holder 270 (e.g., 60A) or may be positioned at the same height.

For example, at least a portion of the heat dissipation member 380 may overlap the coil 230 in a direction perpendicular to the optical axis. At least a portion of the heat dissipation member 380 may overlap at least one of the holder 270 and the magnet 130 in a direction perpendicular to the optical axis. The heat dissipation member 380 may be positioned so as to be spaced apart from the moving unit. The heat dissipation member 380 may overlap at least one of the first heat dissipation member 280, the image sensor 810, and the filter 610 in the optical axis direction.

The heat dissipation member 380 may include a support plate 383 (or lower plate) disposed between the side plate 382 and the upper surface of the second substrate member 800. The support plate 383 may be connected to the side plate 382 and coupled to the second substrate member 800.

For example, a width (W2, see FIG. 14A) of the support plate 383 in the direction perpendicular to the optical axis (or in the direction perpendicular to the side plate 302) may be larger than a width (W1, see FIG. 14A) of the side plate 382 in the direction perpendicular to the optical axis (or in the direction perpendicular to the side plate). This is to increase a contact area between the support plate 383 and the second substrate member 800 and to improve the heat dissipation efficiency.

For example, since the heat dissipation member 380 is a box-shaped member made of a plate, the upper plate 381 can be spaced apart from the upper surface of the second substrate member 800, and an empty space can be formed between the upper plate 381 and the upper surface of the second substrate member 800. By means of this structure of the heat dissipation member 380, a weight of the heat dissipation member 380 can be reduced, and the manufacturing cost can be reduced.

In another embodiment, the heat dissipation member 380 may be in a form in which a space within the upper plate 381 and the side plate 382 is filled with the material of the heat dissipation member 380.

Referring to FIG. 13B, in order to improve heat dissipation efficiency, the heat dissipation member 380 may include a predetermined pattern including at least one groove or at least one unevenness. For example, a groove or an unevenness 381A having the predetermined pattern may be formed on at least one of the upper plate 381, the side plate 382, or the support plate 383 of the heat dissipation member 280. For example, the unevenness 381A may include a convex portion 25A and a concave portion 25B.

For example, the predetermined pattern may include a plurality of grooves formed at a predetermined interval. For example, the predetermined pattern may have a stripe shape. In another embodiment, the predetermined pattern may have a mesh shape, or a mech shape. In another embodiment, the predetermined pattern may have a shape including dots that are spaced apart from each other. For example, the shape of the dot may be circular, oval, or polygonal (e.g., square).

In another embodiment, the heat dissipation member may include a hole or a through hole instead of the groove or the unevenness 381A. The heat dissipation member 380 may be spaced apart from the first substrate member 255 and the heat dissipation member 280. In another embodiment, the unevenness 381A may be omitted.

The coil 230 may be disposed on or coupled to the stationary unit. The coil 230 may be disposed between the first circuit board 250 and the second substrate member 800. For example, at least a portion of the coil 230 may be disposed between the first circuit board 250 and the second substrate member 800.

For example, the coil 230 may be disposed on, coupled to, or mounted on the second substrate member 800. For example, the coil 230 may be disposed on the upper surface of the second substrate member 800. The coil 230 may be disposed under the magnet 130.

The coil 230 may be coupled to the second substrate member 800 by a solder or conductive adhesive. The coil 230 may move the moving unit by interaction with the magnet 130.

For example, the coil 230 may correspond to, face, or overlap the magnet 130 disposed at the moving unit in the optical axis OA direction.

For example, the coil 230 may include a plurality of coil units 230-1 to 230-4. For example, the coil 230 may include four coil units 230-1 to 230-4 disposed in the first region 801 of the second substrate member 800. For example, each of the coil units 230-1 to 230-4 may be disposed to correspond to a corresponding one of the sides of the first region 801 of the second substrate member 800.

Each of the coil units 230-1 to 230-4 may be in the form of a coil block having a closed curve or ring shape. For example, each coil unit may have a hollow or hole. For example, the coil units may be formed as FP (Fine Pattern) coils, or wound coils, or coil blocks. In another embodiment, a protrusion coupled to the hollow of the coil unit may be disposed on the second substrate member 800.

For example, the coil units 230-1 to 230-4 may be disposed to correspond to any one of the side plates of the heat dissipation member 380. For example, when viewed from the top, the heat dissipation member 380 may be disposed on the inner side of the coil units 230-1 to 230-4.

For example, the upper surface of the upper plate 381 may be positioned higher than the upper surface of the coil 230.

For example, the height of the upper plate 381 of the heat dissipation member 380 with respect to the upper surface of the second substrate member 800 may be greater than the height of the upper surface or top portion of the coil 230. This is to improve heat dissipation efficiency by reducing the distance between the heat dissipation member 380 and the first substrate member 255 (or the heat dissipation member 280).

The coil 230 may be conductively connected to the second substrate member 800.

For example, power or a driving signal may be supplied to the first to fourth coil units 230-1 to 230-4 through the second substrate member 800. The power or driving signal supplied to the coil 230 may be a direct current signal or an alternating current signal, or may include a direct current signal and an alternating current signal, and may be in the form of a current or a voltage.

The moving unit may move in the first horizontal direction or the second horizontal direction or roll with respect to the optical axis by the interaction between the first to fourth magnet units 130-1 to 130-4 and the first to fourth coil units 230-1 to 230-4.

For example, current may be independently applied to at least two or more coil units among the four coil units 230-1 to 230-4. For example, two or more of the four coil units 230-1 to 230-4 may be conductively separated, and independent driving signals, for example, driving currents, may be supplied to each of the two or more coil units.

The controller 830 or 780 may supply at least one driving signal to at least one of the first to fourth coil units 230-1 to 230-4, and may move the OIS moving unit in the X-axis direction and/or the Y-axis direction or rotate the OIS moving unit about the optical axis within a predetermined angular range by controlling the at least one driving signal. Hereinafter, the “controller” may be at least one of the controller 830 of the camera device 10, the controller of the camera module 200, or the controller 780 of the optical device 200A.

When the coil 230 is driven by two channels, two independent driving signals can be supplied to the coil 230. For example, two coil units among the four coil units 230-1 to 230-4 can be connected in series with each other, and the remaining two coil units can be connected in series with each other. For example, two coil units e.g., 230-1 and 230-2 disposed opposite each other can be connected in series, and two coil units (e.g., 230-3, 230-4) disposed opposite each other can be connected in series.

And, a first driving signal can be supplied to two coil units (e.g., 230-1, 230-2) connected in series, and a second driving signal can be supplied to the remaining two coil units (e.g., 230-3, 230-4) connected in series. The first and second driving signals may be independent.

When the coil 230 is driven by three channels, three independent driving signals may be supplied to the coil 230. For example, two coil units e.g., 230-1 and 230-2, or 230-3 and 230-4) positioned opposite each other among the four coil units 230-1 to 230-4 may be connected in series. And one driving signal may be supplied to the two coil units (e.g., 230-1 and 230-2) connected in series, and two independent driving signals may be supplied to each of the remaining two coil units (e.g., 230-3 and 23-4 among the four coil units 230-1 to 230-4.

Alternatively, when the coil 230 is driven by 4 channels, an independent driving signal may be supplied to each of the 4 coil units 230-1 to 230-4 that are separated from each other.

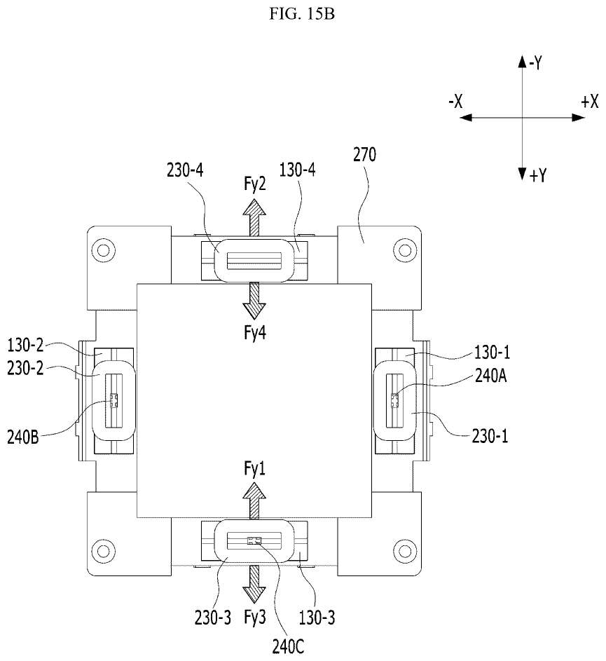

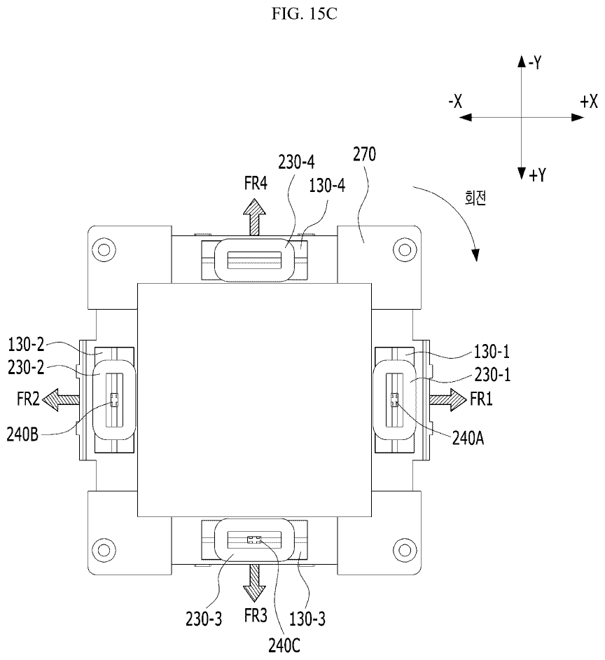

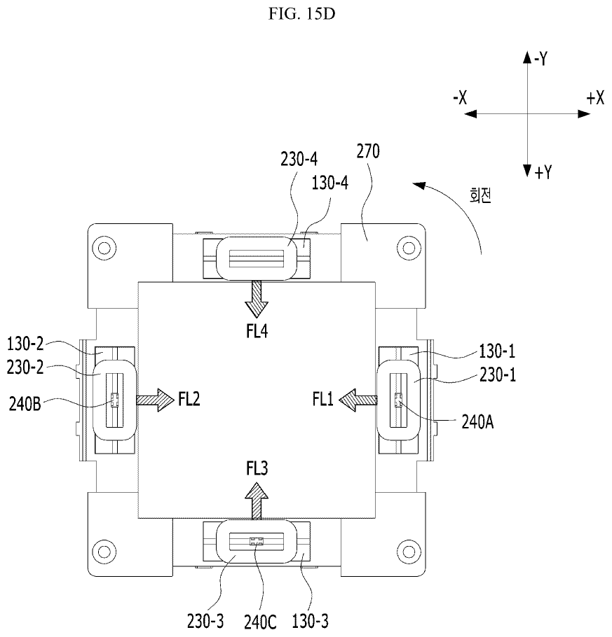

FIG. 15A is for explaining the movement of the moving unit in the X-axis direction, and FIG. 15B is for explaining the movement of the moving unit in the Y-axis direction.

Referring to FIG. 15A, the moving unit can move or shift in the X-axis direction by the first electromagnetic force Fx1 (or Fx3) by the interaction between the first coil unit 230-1 and the first magnet unit 130-1 and the second electromagnetic force Fx2 (or Fx4) by the interaction between the second coil unit 230-2 and the second magnet unit 130-2. For example, the directions of the first electromagnetic force Fx1 (or Fx3) and the second electromagnetic force Fx2 (or Fx4) may be the same direction.

Referring to FIG. 15B, the moving unit can move or shift in the y-axis direction by the third electromagnetic force Fy1 (or Fy3) by the interaction between the third coil unit 230-3 and the third magnet unit 130-3 and the fourth electromagnetic force Fy2 (or Fy4) by the interaction between the fourth coil unit 230-4 and the fourth magnet unit 130-4. For example, the directions of the third electromagnetic force Fy1 (or Fy3) and the fourth electromagnetic force Fy2 (or Fy4) may be the same direction.

In the case of 2 channels, a shifting operation in the X-axis direction or/and the Y-direction can be performed. In the case of 3 channels and 4 channels, a shifting operation in the X-axis direction or/and the Y-direction and a rolling operation with respect to the optical axis as an axis can be performed.

FIG. 15c is for explaining the clockwise rotation of the moving unit when the 4-channel driving is performed, and FIG. 15D is for explaining the counterclockwise rotation of the moving unit when the 4-channel driving is performed.

Referring to FIG. 15c, the moving unit can rotate, tilt, or roll clockwise about the optical axis or with respect to the optical axis as an axis by the first electromagnetic force FR1 by the interaction between the first coil unit 230-1 and the first magnet unit 130-4, the second electromagnetic force FR2 by the interaction between the second coil unit 230-2 and the second magnet unit 130-2, the third electromagnetic force FR3 by the interaction between the third coil unit 230-3 and the third magnet unit 130-3, and the fourth electromagnetic force FR4 by the interaction between the fourth coil unit 230-4 and the fourth magnet unit 130-4.

Also, referring to FIG. 15D, the OIS moving unit can rotate, tilt, or roll counterclockwise about the optical axis or with respect to the optical axis as an axis by the first electromagnetic force FL1 due to the interaction between the first coil unit 230-1 and the first magnet unit 130-1, the second electromagnetic force FL2 by the interaction between the second coil unit 230-2 and the second magnet unit 130-2, the third electromagnetic force FL3 by the interaction between the third coil unit 230-3 and the third magnet unit 130-3, and the fourth electromagnetic force FL4 by the interaction between the fourth coil unit 230-4 and the fourth magnet unit 130-4.

For example, the direction of the first electromagnetic force FR1 (or FL1) and the direction of the second electromagnetic force FR2 (or FL2) can be opposite to each other. Also, for example, the direction of the third electromagnetic force FR3 (or FL3) and the direction of the fourth electromagnetic force FR4 (or FL4) may be opposite to each other. Also, for example, the direction of the first electromagnetic force RF1 (or FL1) and the direction of the third electromagnetic force FR3 (or FL3) may be perpendicular to each other.

In the case of 3-channel driving, a driving signal may not be supplied to two coil units connected in series (e.g., 130-1 and 130-2, or 130-3 and 130-4), and thus, an electromagnetic force may not be generated by the two coil units connected in series.

Compared to the 3-channel driving, the 4-channel driving of FIGS. 15C and 15D can improve the electromagnetic force for rotation of the moving unit, and the driving current for driving the first to fourth coil units 230-1 to 230-4 can be reduced, and power consumption can be reduced.

The position sensor 240 may be disposed on, coupled to, or mounted on the second substrate member 800.

The position sensor 240 may detect movement or displacement of the moving unit in a direction perpendicular to the optical axis direction. For example, the position sensor 240 may detect shift or movement of the moving unit in a direction perpendicular to the optical axis direction. In addition, the position sensor 240 may detect rotation, rolling, or tilting of the moving unit within a predetermined range with respect to the optical axis or with the optical axis as an axis. The position sensor 240 may also be expressed as an “OIS position sensor.” The position sensor 240 may detect the magnet 130.

The position sensor 240 may face or overlap the magnet 130 in the optical axis direction. For example, the position sensor 240 may face or overlap at least two or more of the magnet units 130-1 to 130-4 of the magnet 130 in the optical axis direction.

For example, the position sensor 240 may include a plurality of sensors. For example, the position sensor 240 may include sensors 240A to 240C corresponding to or overlapping three or more of the four magnet units 130-1 to 130-4 of the magnet 130 in the optical axis direction to detect the movement of the moving unit.

For example, the position sensor 240 may be disposed within the hollow of the coil 230. In another embodiment, the position sensor 240 may be disposed outside the hollow of the coil 230. In another embodiment, the position sensor 240 may be disposed on the outside of the coil 230 when viewed in the optical axis direction or viewed from the top.

For example, the position sensor 240 may not overlap the coil 230 in the optical axis direction. For example, the sensing element of the position sensor 240 may not overlap the coil 230 in the optical axis direction. The sensing element may be a portion that detects a magnetic field.

In another embodiment, at least a portion of the position sensor 240 may not overlap the coil 230 in the direction perpendicular to the optical axis. For example, at least a portion of the position sensor 240, for example, a center of the position sensor 240, may not overlap the coil 230 in the optical axis direction.

For example, the position sensor 240 may include a first sensor 240A, a second sensor 240B, and a third sensor 240C that are spaced apart from each other.

For example, each of the first to third sensors 240A, 240B, and 240C may be a hall sensor. In another embodiment, each of the first to third sensors 240A, 240B, and 240C may be a driver IC including a hall sensor and a driver.

For example, each of the first to third sensors 240A, 240B, and 240C may be a displacement detection sensor whose output voltage changes according to the position (or relationship) with the corresponding magnet unit 130-1 to 130-3. For example, each of the first sensor 240, the second sensor 240B, and the third sensor 240C may be conductively connected to the second substrate member 800.

For example, the first sensor 240A may be disposed in the hollow of the first coil unit 230-1. The first sensor 240A may overlap the first magnet unit 130-1 in the optical axis direction. The second sensor 240B may be disposed in the hollow of the second coil unit 230-2. The second sensor 240B may overlap the second magnet unit 130-2 in the optical axis direction. The third sensor 240C may be disposed in the hollow of the third coil unit 230-3. The third sensor 240C may overlap the third magnet unit 130-3 in the optical axis direction.

For example, the first sensor 240A may output a first output signal (e.g., a first output voltage) according to the result of detecting the magnetic field of the first magnet unit 130-1. For example, the second sensor 240B may output a second output signal (e.g., a second output voltage) according to the result of detecting the magnetic field of the second magnet unit 130-2. For example, the third sensor 240C may output a third output signal (e.g., a third output voltage) according to the result of detecting the magnetic field of the third magnet unit 71B3.

In order to improve the linearity of the relationship between the displacement of the moving unit and the output of the second position sensor 240, at least a portion of each sensor unit 240A, 240B, and 240C within the stroke range of the moving unit may overlap the corresponding magnet unit 130-1, 130-2, and 130-3 in the optical axis direction.

The controller 830 or 780 can control the rolling of the moving unit by using at least one of the first output voltage of the first sensor 240A, the second output voltage of the second sensor 240B, and the third output voltage of the third sensor 240C.

For example, the controller 830 or 780 can control or adjust the movement or displacement of the OIS moving unit in the first horizontal direction or the second horizontal direction by using at least one of the first to third output voltages. For example, the controller 830 or 780 can control or adjust the movement or displacement of the OIS moving unit in the first horizontal direction by using the first output voltage of the first sensor 240A, and can control or adjust the movement or displacement of the moving unit in the second horizontal direction by using the second output voltage of the second sensor 240B.

For example, each of the first to third sensors 240A, 240B, and 240C may be a Hall sensor. In another embodiment, each of the first to third sensors may be a driver IC including a Hall sensor. In another embodiment, each of the first and second sensors 240A and 240B may be a Hall sensor, and the third sensor 240C may be a TMR (Tunnel MagnetoResistance) sensor. In this case, the TMR (Tunnel MagnetoResistance) sensor may be a TMR magnetic angle sensor.

In another embodiment, each of the first to third sensors 240A, 240B, and 240C may be a TMR (Tunnel MagnetoResistance) sensor. In this case, the TMR sensor may be a TMR linear magnetic field sensor whose output is linear according to the displacement (or stroke) of the moving unit.

In another embodiment of the two-channel operation, one of the second sensor 230B and the third sensor 230C (e.g., 230C) may be omitted.

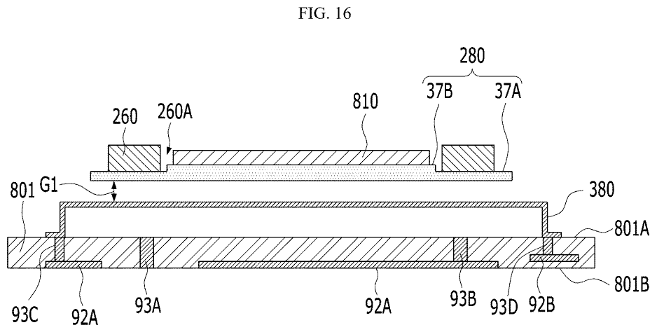

FIG. 16 illustrates a simplified cross-sectional view of the first substrate member 255, the image sensor 810, and the second substrate member 800.

Referring to FIG. 16, the image sensor 810 may be disposed within the opening 260A (or hole) of the second circuit board 260 and may be coupled with the heat dissipation member 280.

For example, the heat dissipation member 28) may include a body 37A disposed under the second circuit board 260 and a protruding portion 37B (or protruding region) protruding from the body 37A and disposed within the opening 260A of the second circuit board 260.

The image sensor 810 may be disposed on, coupled to, or fixed to the protruding portion 37B. For example, the image sensor 810 may be disposed on, coupled to, or attached to the upper surface of the protruding portion 37B. For example, the upper surface of the protruding portion 37B may be positioned lower than the upper surface of the second circuit board 260. In another embodiment, the upper surface of the protrusion 37B may be positioned at the same height as the upper surface of the second circuit board 260. For example, the upper surface of the image sensor 810 may be positioned lower than the upper surface of the second circuit board 260. In another embodiment, the upper surface of the image sensor 810 may be positioned higher than or at the same height as the upper surface of the second circuit board 260.

In another embodiment, the protruding portion 37B of FIG. 13B of the heat dissipation member 280 may be omitted.

The heat dissipation member 380 may be disposed on the upper surface of the first region 801 of the second substrate member 800 facing the heat dissipation member 280 in the optical axis direction.

A separation distance G1 (or gap) in the optical axis direction between the first substrate member 255 and the second substrate member 800 may be 0.05 [mm] to 0.7 [mm]. For example, the separation distance G1 may be a distance between the lower surface of the heat dissipation member 280 and the upper surface of the upper plate 381 of the heat dissipation member 380.

In another embodiment, G1 may be 0.15 [mm] to 0.5 [mm]. In another embodiment, G1 may be 0.15 [mm] to 0.3 [mm]. In another embodiment, G1 may be 0.2 [mm] to 0.3 [mm].

For example, the second substrate member 800 may include a conductive layer 93C, 93D that is exposed to the upper surface 801A of the second substrate member 800 and contacts or is connected to the heat dissipation member 380.

For example, the conductive layer 93C, 93D may contact or be connected to the support plate 383 of the heat dissipation member 380. Or, the conductive layer 93C, 93D may contact or be connected to the lower surface of the heat dissipation member 380.

For example, the conductive layer 93C, 93D may be thermally bonded to the heat dissipation member 380 or may be bonded by a conductive adhesive, such as solder. Also, for example, the conductive layer 93C, 93D may be conductively connected to the heat dissipation member 380.

The conductive layers 93C, 93D may be in the form of a via that passes through at least a portion of the second substrate member 800. For example, the substrate member 800 may include a via 93C, 93D that is opened to the upper surface 801A of the second substrate portion 800 and contacts or is connected to the heat dissipation member 380.

For example, the substrate member 800 may include a via 93A, 93B that is opened or exposed to at least one of the lower surface 801B and the upper surface 801A of the second substrate member 800.

For example, the second substrate member 800 may include at least one conductive layer 92A, 92B. For example, the second substrate member 800 may include a first conductive layer 92A formed on the lower surface 801B of the second substrate member 800 and a second conductive layer 92B formed inside the second substrate member 800.

For example, vias 93B, 93C may be in contact with or connected to the first conductive layer 92A. For example, vias 93D may be in contact with or connected to the second conductive layer 92B. At least one of the first conductive layer 92A or the second conductive layer 92B may be conductively connected to the ground (or ground terminal) of the second substrate member 800.

The vias 93A, 93B, 93C, 93D and the conductive layers 92A, 92B may serve as heat dissipation patterns or heat dissipation pads for heat dissipation of the second substrate member 800. For example, since the conductive layers 92A, 92B are simply for heat dissipation purposes, they may not be conductively connected to other wirings of the second substrate member 800 except for the ground of the second substrate member 800. At this time, the other wirings may be wirings which are conductively connected to electronic components (or circuit components) such as the controller 830 or 780 and the image sensor 810, or the support board 310.

The conductive layer 92A or 92B may be conductively connected to the cover member 300 (e.g., the side plate 302) through a solder, a conductive adhesive, or a conductive tape. Or, in another embodiment, the second conductive layer 92A connected to the ground of the second substrate member 800 and the cover member 300 may be conductively connected by a bracket. The bracket may be an apparatus in which the camera device is received or accommodated in order to protect the camera device. For example, the bracket may be made of a conductive material. Since the ground and the heat dissipation member 380 of the second substrate member 800 and the cover member 300 are conductively connected, the camera device 10 can be protected from static electricity and the heat dissipation efficiency can be improved.

Since the heat dissipation member 380 is disposed on the upper surface of the second substrate member 800, the distance from the heat dissipation member 280 can be reduced, and the heat dissipation efficiency can be improved.

The heat dissipated from the heat dissipation member 280 can be transferred to the heat dissipation member 380 through the convection or the radiation, and the transferred heat can be released to the outside through the heat dissipation member 380, and the heat dissipation effect can be improved. Since the upper surface of the heat dissipation member 380 and the lower surface of the heat dissipation member 280 are disposed to face each other or overlap each other in the optical axis direction, heat can be transferred well from the heat dissipation member 280 to the heat dissipation member 380.

The description of the material of the heat dissipation member 280 can be applied or analogically applied to the heat dissipation member 380. For example, the heat dissipation member 280 and the heat dissipation member 380 can be formed of the same material. In other embodiments, the heat dissipation member 280 and the heat dissipation member 380 may be formed of different materials. For example, the thermal conductivity of the heat dissipation member 280 may be applied to or analogically applied to the heat dissipation member 380.

In other embodiments, the heat dissipation member 380 may be formed of a heat dissipation member having high thermal conductivity, such as a heat dissipation epoxy, a heat dissipation plastic, or a heat dissipation synthetic resin.

The support board 310 may support the OIS moving unit relative to the stationary unit so that the OIS moving unit may move in a direction perpendicular to the optical axis, or the OIS moving unit may tilt or rotate about the optical axis within a predetermined range.

The support board 310 can conductively connect the first substrate member 255 and the second substrate member 800. For example, a portion of the support board 310 can be connected or coupled with the first substrate member 255, and another portion of the support board 310 can be connected or coupled with the second substrate member 800.

The support board 310 can be expressed as a “support member,” a “connection board,” or a “connection member.” Alternatively, the support board 310 can be expressed as an “interposer.” Alternatively, the “interposer” may include the first circuit board 250 and the support board 310 formed integrally.

The support board 310 may include or be a flexible substrate. For example, the support board 310 may include a flexible printed circuit board (FPCB). At least a portion of the support board 310 may have flexibility. The first circuit board 250 and the support board 310 may be connected to each other.

Referring to FIG. 9, for example, the support board 310 may include a connecting portion 320 connected to the first circuit board 250. For example, the first circuit board 250 and the support board 310 may be formed integrally. In another embodiment, the first circuit board 250 and the support board 310 may be configured separately rather than integrally, and may be connected to each other by the connecting portion 320 and may be conductively connected. Alternatively, in another embodiment, the connecting portion 320 may be formed integrally with at least one of the support board 310 or the first circuit board 250.

In addition, the support board 310 may be conductively connected to the first circuit board 250. The support board 310 may be conductively connected to the second substrate member 800. For example, a portion of the support board 310 may be connected or coupled to the first substrate member 255, for example, the first circuit board 250. In addition, the other end of the support board 310 may be connected or coupled to the second substrate member 800.

The support board 310 may support the moving unit with respect to the stationary unit. In addition, the support board 310 may guide the movement of the moving unit. The support board 310 may guide the moving unit to move in a direction perpendicular to the optical axis direction. The support board 310 may guide the moving unit to rotate, tilt, or roll about the optical axis as an axis. The support board 310 may restrict the movement of the moving unit in the optical axis direction.

At least a portion of the support board 310 may be coupled, attached, or fixed to the housing 140, which is the stationary unit, and at least another portion of the support board 310 may be coupled, attached, or fixed to the holder 270, which is the moving unit.

Referring to FIGS. 9 and 12, for example, the body 86 and 87 of the support board 310 may be coupled to the housing 140 and the holder 270. For example, a portion of the body 86 and 87 may be coupled to the mounting portion 149 of the housing 140, and another portion of the body 86 and 87 may be coupled to the protruding portion 275 of the holder 270. The terminal portions 7A to 7D of the support board 310 may be coupled to the terminals of the second substrate member 800 and may be conductively connected.

The support board 310 may include a circuit member and an elastic member coupled to the circuit member. The elastic member may be implemented as an elastic body, for example, a spring, for elastically supporting the OIS moving unit. The elastic member may include a metal or may be made of an elastic material. The circuit member is for conductively connecting the first circuit board 250 and the second substrate member 800, and may be a flexible substrate or may include at least one of a flexible substrate and a rigid substrate. For example, the circuit member may be an FPCB.

The support board 310 may be connected to the first substrate member 255 (e.g., the first circuit board 250) and may include at least one connecting portion 320A and 320B conductively connected to the first substrate member 255 (e.g., the first circuit board 250).

In addition, the support board 310 may be connected to the second substrate member 800 and may include at least one terminal portion 7A to 7D conductively connected to the second substrate member 800, and at least one terminal portion 7A to 7D may include a plurality of terminals 311.

The support board 310 may include a body 86 and 87. The support board 310 may include at least one terminal portion 7A to 7D connected to the body 86 and 87.

For example, the terminal portion 7A to 7D of the support board 310 may extend from the body 86 and 87 in a direction from the lower surface of the housing 140 toward the upper surface of the housing 140. Here, the extension portion of the support board 310 may be expressed as a “protruding portion.” For example, when the OIS operation is driven, the terminal portion 7A to 7D may be movable.

For example, the support board 310 may include a first support board 310A and a second support board 310B that are spaced apart from each other. The first and second support boards 310A and 310B may be formed symmetrically left and right. In another embodiment, the first support board 310A and the second support board 310B may be formed as a single integral substrate. In another embodiment, the support board 310 may include three or more support boards that are spaced apart from each other.

The first and second support boards 310A and 310B may be disposed on both sides of the first circuit board 250. For example, the first support board 310A may include a first body 86 and at least one terminal portion 7A and 7B extending from the first body 86. At least one terminal portion 7A and 7B of the first support board 310A may include a plurality of terminals 311.

The second support board 310B may include a second body 87 and at least one terminal portion 7C and 7D extending from the second body 87. At least one terminal portion 7C and 7D of the second support board 310B may include a plurality of terminals 311.

The first circuit board 250 may include a first side portion 33A and a second side portion 33B positioned opposite each other, and a third side portion 33) and a fourth side portion 33D positioned between the first side portion 33A and the second side portion 33B and positioned opposite each other.

Referring to FIG. 7, for example, the first connecting portion 320A can connect the first body 86 and the side portion 33D of the first circuit board 250, and the second connecting portion 320B can connect the second body 87 and the side portion 33C of the first circuit board 250.

The first body 86 can include a first portion 6A corresponding to or facing the side portion 33D of the first circuit board 250, a second portion 6B corresponding to or facing a part (or one side) of the side portion 33A of the first circuit board 250, and a third portion 6C corresponding to or facing a part (or one side) of the side portion 33B of the first circuit board 250. In addition, the first body 86 may include a first bent portion 6D that connects one end of the first portion 6A and the second portion 6B and is bent from one end of the first portion 6A, and a second bent portion 6E that connects the other end of the first portion 6A and the third portion 6C and is bent from the other end of the first portion 6A.

For example, the first support board 310A may include a first terminal portion 7A and a second terminal portion 7B. For example, the first terminal portion 7A may extend or protrude from the second portion 6B of the first body 86 in a direction toward the upper surface of the housing 140 from the lower surface of the housing 140, and the second terminal portion 7B may extend or protrude from the third portion 6C of the first body 86 in a direction from the lower surface of the housing 140 toward the upper surface of the housing 140. The first terminal portion 7B may be positioned at the opposite side of the first terminal portion 7A with the first substrate member 255 (e.g., the first circuit board 250) interposed therebetween.

For example, the first connecting portion 320A may connect the first portion 6A of the first body 86 and the side portion 33D of the first circuit board 250. The first connecting portion 320A may include a bent portion.

The second body 87 may include a first portion 9A corresponding to or facing the side portion 33C of the first circuit board 250, a second portion 9B corresponding to or facing another part (or the other side) of the side portion 33A of the first circuit board 250, and a third portion 9C corresponding to or facing another part (or the other side) of the side portion 33B of the first circuit board 250. In addition, the second body 87 may include a first bent portion 9D connecting one end of the first portion 9A and the second portion 9B and being bent from one end of the first portion 9A, and a second bent portion 9E connecting the other end of the first portion 9A and the third portion 9C and being bent from the other end of the first portion 9A.

For example, the second support board 310B may include a third terminal portion 7C and a fourth terminal portion 7D.

The third terminal portion 7C may extend or protrude from the second portion 9B of the second body 87 in a direction from the lower surface of the housing 140 toward the upper surface of the housing 140, and the fourth terminal portion 7D may extend or protrude from the third portion 9C of the second body 87 in a direction from the lower surface of the housing 140 toward the upper surface of the housing 140. The fourth terminal portion 7D may be positioned at the opposite side of the third terminal portion 7C with the first substrate member 255 (e.g., the first circuit board 250) interposed therebetween.

For example, the second connecting portion 320B may connect the first portion 9A of the second body 87 and the side portion 33C of the first circuit board 250. The second connecting portion 320B may include a bent portion.

Referring to FIG. 7, the support board 310 may include a conductive layer 93-1. In addition, the support board 310 may include a first insulating layer 94-1 disposed on one surface (or first surface) or one side of the conductive layer 93-1. In addition, the support board 310 may include a second insulating layer 94-2 disposed on the other surface (or second surface) or the other side of the conductive layer 93-1.

Referring to FIGS. 7, 8A, 9, and 12, the holder 270 may include first to fourth side portions 271-1 to 271-4 corresponding to or facing the first to fourth side portions 33A to 33D of the first circuit board 250.

At least a portion of the support board 310 may be attached or coupled to the holder 270. For example, at least one connecting portion 320A and 320B of the support board 310 may be coupled to at least one of the first to fourth side portions 271-1 to 271-4 of the holder 270 by an adhesive. For example, the first connecting portion 320A may be coupled, attached, or fixed to the side portion 271-4 of the holder 270 by an adhesive, and the second connecting portion 320B may be coupled, attached, or fixed to the side portion 271-3 of the holder 270.

At least a portion of the support board 310 may be coupled, attached, or fixed to the housing 140. For example, the bodies 86 and 87 of the support board 310 may be coupled to the housing 140 by an adhesive. For example, at least a portion of the terminal portions 7A to 7D may be coupled to the housing 140.

For example, the terminal portions 7A and 7C of the support board 310 may be coupled, attached, or fixed to the first mounting portion 149A of the housing 140, and the terminal portions 7B and 7D of the support board 310 may be coupled, attached, or fixed to the second mounting portion 149B of the housing 140.

A first coupling region 69A may be formed between the first body 86 of the first support board 310A and the first protruding portion 275A of the holder 270 and between the first connecting portion 320A and the first protruding portion 275A of the holder 270. A second coupling region 69B may be formed between the second body 87 of the second support board 310B and the second protruding portion 275B of the holder 270 and between the second connecting portion 320B and the second protruding portion 275B of the holder 270.

In addition, a third coupling region 59A may be formed between the terminal portions 7A and 7C of the first and second support boards 310A and 310B and the first mounting portion 149A of the housing 140. A fourth coupling region 59B may be formed between the terminal portions 7B and 7D of the first and second support boards 310A and 310B and the second mounting portion 149B of the housing 140.

By the support board 310 and the first to fourth coupling regions 69A, 69B, 59A, and 59B, the moving unit may be elastically supported relative to the stationary unit. The terminals 311 of the support board 310 may be bonded to the terminals of the second substrate member 800 by solder or a conductive adhesive, and may be conductively connected.

The camera device 10 may include a controller 830. In addition, the camera device 10 may include at least one of a memory (not shown) and a capacitor (not shown).

The controller 830 may be disposed to be apart from the first substrate member 255. For example, the controller 830 may be disposed at the second substrate member 800.

In FIG. 3, the controller 830 is disposed on or coupled to the upper surface of the extension region 808 of the second substrate member 800, but in other embodiments, the controller 830 may be disposed on or coupled to the lower surface of the extension region 808.

In FIG. 3, the controller 830 is disposed at the extension region 808 of the second substrate member 800 which is located outside the cover member 300, but in another embodiment, the controller 830 may be disposed at the first region 801 of the second substrate member 800 which is located inside the housing 140.

In another embodiment, the controller 830 may be disposed or mounted on the second circuit board 260. For example, in another embodiment, the controller may be disposed or mounted on the upper surface of the second circuit board 260. Since the heat dissipation member 280 is disposed on or coupled to the lower surface of the second circuit board 260, when the controller is disposed on the second circuit board 260, heat generated by the controller may be easily dissipated by the heat dissipation member 280, and heat dissipation efficiency and heat dissipation performance can be improved. In another embodiment, the controller may be disposed or mounted on the first circuit board 250.

For example, the memory may be disposed on any one of the first substrate member 255 and the second substrate member 800. For example, the capacitor 514 may be disposed on at least one of the first substrate member 255 and the second substrate member 800.

The memory can store data values (or code values) corresponding to the output of the position sensor 240 according to the displacement (or stroke) of the OIS moving unit in a direction perpendicular to the optical axis (e.g., X-axis direction or Y-axis direction) for OIS feedback driving. For example, each of the data values can be stored in the memory in the form of a lookup table. Alternatively, each of the data values can be stored in the memory in the form of a mathematical formula or an algorithm. In addition, the memory can store a mathematical formula, an algorithm, or a program for the operation of the controller 830. For example, the memory can be a nonvolatile memory, such as an Electrically Erasable Programmable Read-Only Memory (EEPROM). In another embodiment, the memory can be included in the controller 830.

In a sensor shift camera device in which an image sensor moves for image stabilization, since the OIS moving unit including the image sensor and the first substrate member is disposed separately from the stationary unit including the second substrate member, it is not easy for the heat generated from the OIS moving unit to be discharged to the outside through the stationary unit. In addition, in the sensor shift camera device, the AF driving unit and the OIS driving unit may be structured to be confined in the cover member for the purpose of preventing foreign matter defects, and thus, the heat may not be easily discharged to the outside of the camera device.

The image sensor, the second coil, and the controller may correspond to heat sources. Here, the “controller” may be a driver IC for controlling the OIS operation.

In another embodiment, the camera device 10 may include a heat dissipation member (not shown) disposed on, coupled to, or attached to the extension region 808 to enhance the heat dissipation effect.

The camera device 10 may include a cover can 405 that is disposed on the extension region 808 to protect the controller 830 from external impact and accommodates the controller 830 inside. The cover can 405 may include a top plate and a side plate that is connected to the top plate 405A and extends from the top plate toward the extension region 808. The cover can 405 may be disposed on, coupled to, or fixed to the upper surface of the extension region 808. For example, the lower portion, the lower end, or the lower surface of the side plate 405B of the cover can 405 may be coupled, attached, or fixed to the upper surface of the extension region 808.

Since the cover can 405 accommodates the controller 830 inside, heat generated from the controller 830 may be suppressed from being emitted to the outside of the cover can 405 and transmitted to the image sensor. The description of the material of the heat dissipation member 280 or the material of the cover member 300 can be applied or analogically applied to the cover can 405.

The controller 830 may be conductively connected to the position sensor 240. The controller 830 may adjust or control the driving signal supplied to the coil 230 using the output signals received from the sensors 240A, 240B, and 240C of the position sensor 240 and the data values stored in the memory, and may perform a feedback OIS operation.

The controller 830 may be implemented in the form of a driver IC, but is not limited thereto. For example, the controller 830 may be conductively connected to the terminals of the second substrate member 800.

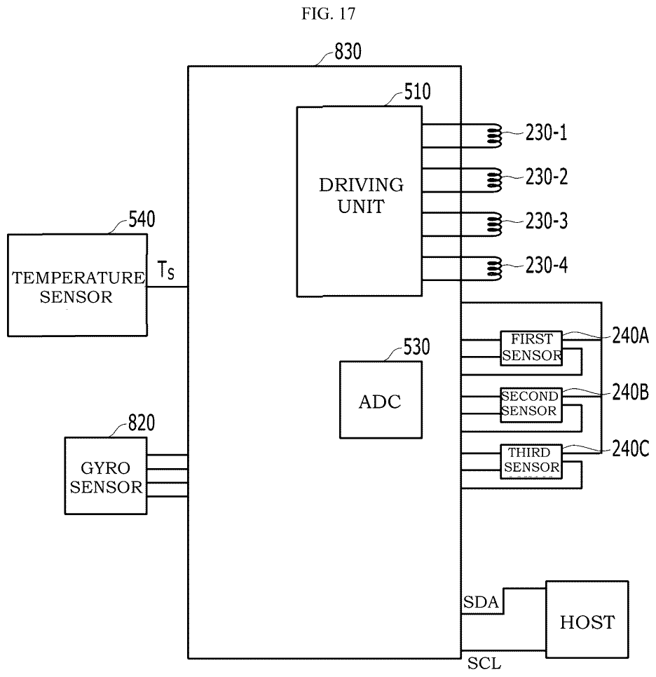

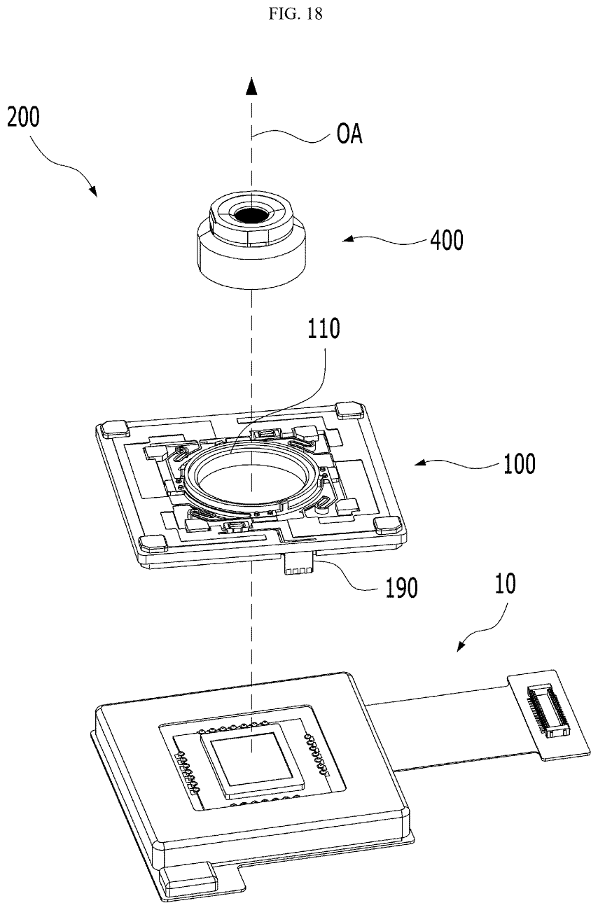

The controller 830 may control the position sensor 240. For example, the controller 830 may supply a driving signal to the position sensor 240. The camera device 10 may further include a motion sensor 820 (see FIG. 17) disposed on any one of the first substrate member 255 or the second substrate member 800. The motion sensor may be conductively connected to the controller 830. The motion sensor 820 may output rotational angular velocity information due to the movement of the camera device 10. For example, the motion sensor 820 may be implemented as a two-axis or three-axis gyro sensor or an angular velocity sensor. For example, the motion sensor 820 may output information on the amount of movement in the X-axis direction, the amount of movement in the Y-axis direction, and the amount of rotation due to the movement of the camera device 10.

In another embodiment, the motion sensor 820 may be omitted from the camera device 10, and the motion sensor may be provided in at least one of the camera device 200 or the optical device 200A.

The camera device 10 may further include a filter 610 disposed above the image sensor 810. The camera device 10 may further include a filter holder 600 for disposing, fixing, or accommodating the filter 610. The filter holder 600 may be alternatively expressed as “sensor base.”

The filter 610 may block or allow light of a specific frequency band in light passing through the lens barrel 400 to pass through or to be incident on the image sensor 810. For example, the filter 610 may be an infrared cutoff filter. For example, the filter 610 may be disposed parallel to an x-y plane perpendicular to the optical axis OA. The filter 610 may be disposed under the lens module 400.

For example, the filter holder 600 may be disposed on the first substrate member 255. For example, the filter holder 600 may be disposed on the upper surface of the second circuit board 260 of the first substrate member 255.

The filter holder 600 may be bonded to one region of the second circuit board 260 around the image sensor 810 by an adhesive. The filter holder 600 may be exposed by an opening 303 of the cover member 300. The filter holder 600 may have an opening 61A (see FIG. 3A) formed at the region where the filter 610 is mounted or disposed so that light passing through the filter 610 may be incident on the image sensor 810. The opening 61A of the filter holder 600 may be a through hole shape that penetrates the filter holder 600 in the optical axis direction. For example, the opening 61A of the filter holder 600 may penetrate a center of the filter holder 600 and may be disposed to correspond to or face the image sensor 810.

The filter holder 600 may have a mounting portion 500 that is depressed from the upper surface and on which the filter 610 is mounted, and the filter 610 may be disposed, seated, or mounted on the mounting portion 500. The mounting portion 500 may be formed to surround the opening 61A. In another embodiment, the mounting portion of the filter holder may be in the form of a protrusion that protrudes from the upper surface of the filter holder.

The camera device 10 may further include an adhesive disposed between the filter 610 and the mounting portion 500, and the filter 610 may be coupled or attached to the filter holder 600 by the adhesive.

For example, the camera device 10 may include a sensor unit (or “image sensor unit”) including an image sensor. For example, the sensor unit (or image sensor unit) may further include at least one of the sensor board 260, the filter holder 600, the heat dissipation member 280, or the filter 610. For example, the sensor unit (or image sensor unit) may include the sensor board 260 and the heat dissipation member 280 coupled with the sensor board 260. The terminal 251 coupled with the image sensor unit may be formed on the upper surface of the circuit board 250.

The embodiment may provide an actuator for driving or moving the image sensor, and the actuator may not include the sensor unit (or image sensor unit) described above in the camera device 10 according to the embodiment.

FIG. 17 shows a block diagram regarding the configuration of the controller 830, the coil units 230-1 to 230-4, and the first to third sensors 240A, 240B, and 240C.

Referring to FIG. 17, the controller 830 can perform communication, such as I2C communication, for exchanging data with the host (Host) using a clock signal SCL and a data signal SDA. For example, the host can be the controller of the camera module 200A or the controller 780 of the optical device 200A.

The controller 830 may be conductively connected to the coil 230. The controller 830 may include a driving unit 510 for supplying a driving signal for driving the first to fourth coil units 230-1 to 230-4. For example, the driving unit 510 may include an H-bridge circuit or an H-bridge driver that may change the polarity of the driving signal. At this time, the driving signal may be a PWM signal to reduce the consumption current, and the driving frequency of the PWM signal may be 20 [KHz] or more, which is outside the audible frequency range. In another embodiment, the driving signal may be a DC signal.

Each of the first to third sensors 240A to 240C may include two input terminals and two output terminals. The controller 830 can supply power or a driving signal to two input terminals of each of the first to third sensors 240A to 240C. For example, one of the two input terminals of the first to third sensors 240A to 240C can be commonly contacted to each other. For example, the two input terminals can be a (+) input terminal and a (−) input terminal (e.g., a ground terminal).

For example, the controller 830 can receive a first output voltage of the first sensor 240A, a second output voltage of the second sensor 240B, and a third output voltage of the third sensor 240C, and control movement (or displacement) of the moving unit in the X-axis direction or the Y-axis direction using at least one of the received first to third output voltages. Additionally, the controller 830 can control rotation, tilting, or rolling of the moving unit based on the optical axis using at least one of the received first to third output voltages.

In addition, the controller 830 may include an analog-to-digital converter 530 that receives output voltages output from two output terminals of each of the first to third sensors 240A to 240C and outputs data values, digital values, or code values according to the results of analog-to-digital conversion of the received output voltages. The controller 830 may control movement of the moving unit in the X-axis direction or the Y-axis direction (or displacement and rotation, tilting, or rolling of the moving unit based on the optical axis) using at least one of the data values output from the analog-to-digital converter 530.

The temperature sensor 540 may measure the ambient temperature (e.g., the temperature of the first to third sensors 240A, 240B, and 240C) and output a temperature detection signal Ts according to the measured results. For example, the temperature sensor 540 may be a thermistor.

The resistance value of the resistor included in the temperature sensor 540 may change depending on the ambient temperature, and thus the temperature detection signal Ts may change in value depending on the ambient temperature. Through calibration, a mathematical expression or a lookup table regarding the relationship between the ambient temperature and the temperature detection signal Ts may be stored in the memory or the controller 830 or 780.

Since the output values of the first to third sensors 240A, 240B, and 240C are also affected by the temperature, compensation of the output values of the first to third sensors 240A, 240B, and 240C depending on the ambient temperature is necessary for accurate and reliable OIS feedback operation.

For this purpose, for example, the controller 830 or 780 may compensate for the output values (or data values related to the output) of each of the first to third sensors 240A, 240B, and 240C using the ambient temperature measured by the temperature sensor 540 and the temperature compensation algorithm or compensation formula. The temperature compensation algorithm or compensation formula may be stored in the controller 830 or 780 or memory.

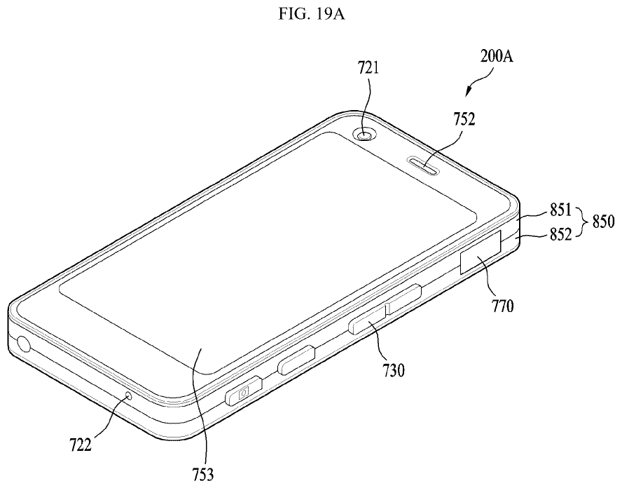

In a comparative example where the image sensor 810 is disposed at the lower portion of the first substrate member 255, there may be restrictions on reducing a distance between the image sensor 810 and the lens barrel 400. The distance between the lens barrel 400 and the image sensor 810 is provided with a predetermined specification, and the position of the lens barrel 400 in the AF actuator 100 (see FIG. 18) may be restricted by the predetermined specification. If the image sensor 810 can be disposed close to the lens barrel 400, the degree of freedom for the design position of the lens barrel 400 in the AF actuator 100 (see FIG. 18) can be improved. In the embodiment, the distance between the lens barrel 400 and the image sensor 810 can be reduced for the following reasons, and thus the degree of freedom for the design position of the lens barrel in the AF actuator 100 of the camera device can be improved.

In the embodiment, the image sensor 810 is disposed at the upper side of the first circuit board 250 of the first substrate member 255, so that the distance between the lens barrel 400 and the image sensor 810 can be reduced. That is, in the embodiment, the distance between the image sensor 810 and the second substrate member 800 can be increased, and the distance between the image sensor and the cover member 300 can be reduced.

For example, the upper surface of the image sensor 810 can be positioned higher than the upper surface of the first circuit board 250. Also, for example, the lower surface of the image sensor 810 can be positioned higher than the upper surface of the first circuit board 250. In another embodiment, the lower surface of the image sensor 810 and the upper surface of the first circuit board 250 can be positioned at the same height.

In a comparative example where the coil 230 is disposed on the first substrate member 255 or the holder 270 which is the moving unit, a circuit pattern or wiring for electrical connection between the coil 230 and the second substrate member 800 is required on the support board 310, and when such a circuit pattern or wiring is formed, a length of the support board 310 in the optical axis direction can be increased.

However, in the embodiment, since the coil 230 is not disposed on the moving unit, the magnet 130 is disposed on the moving unit (e.g., the holder 270), and the coil 230 is disposed on the second substrate member 800, the supporting board 310 does not require a circuit pattern or wiring for electrical connection between the coil units 230-1 to 230-4 of the coil 230 and the second substrate member 800, and thus the length of the supporting board 310 in the optical axis direction can be reduced, and a length of the camera device 10 in the optical axis direction can be reduced, and thus a size of the camera device 10 can be reduced.

In addition, in the comparative example where the terminal portion of the support board extends from the body of the support board toward the second substrate member 800, the length of the support board in the optical axis direction can be increased. However, in the embodiment, since the terminal portions 7A to 7D of the support board 310 extend upward from the lower surface of the housing 140 from the body 86 and 87, the length of the support board 310 in the optical axis direction can be reduced, and thus the length of the camera device 10 in the optical axis direction can be reduced, and thus the size of the camera device 10 can be reduced.

In addition, in the embodiment, the height of the image sensor 810 increases with respect to the upper surface of the second substrate member 800, and at the same time, the height of the first heat dissipation member 280 also increases with respect to the upper surface of the second substrate member 800. In the embodiment, the height of the second heat dissipation member 380 (e.g., the height of the upper plate 381) is increased based on the upper surface of the second substrate member 800 in accordance with the increased height of the first heat dissipation member 280. By means of this, in the embodiment, a decrease in heat dissipation efficiency can be prevented and heat dissipation efficiency can be increased.

FIG. 18 shows an exploded perspective view of a camera device 200 according to another embodiment.

Referring to FIG. 18, the camera device 200 may further include the lens module 400 and an AF actuator 100.

The lens module 400 may include at least one lens and/or a lens barrel. For example, the lens module 400 may include one or more lenses and a lens barrel that accommodates the one or more lenses. However, the configuration of the lens module is not limited to the lens barrel, and any holder structure capable of supporting one or more lenses may be used.

The lens module 400 may be coupled with the AF actuator 100. For example, the AF actuator 100 may include a bobbin 110 coupled with the lens module 400. The AF actuator 100 can move the bobbin 110 in the optical axis direction or the first direction. The AF actuator 100 can move the lens module 400 coupled to the bobbin 110 in the optical axis direction or the first direction. The AF actuator 100 can perform an ‘auto focusing function’. Here, the auto focusing function refers to automatically focusing the image of a subject on the imaging region of the image sensor.

The AF actuator 100 can include a circuit board 190. For example, the circuit board 190 can be electrically connected to an external device, for example, the optical device 200A. Alternatively, the circuit board 190 can be electrically connected to at least one of the first substrate member 255, the support board 310, and the second substrate member 800 of the camera device 10.

In addition, the camera device 200 according to the embodiment may be included in an optical instrument for the purpose of forming an image of an object present in a space using reflection, refraction, absorption, interference, and diffraction, which are characteristics of light, for the purpose of increasing visibility, for the purpose of recording and reproduction of an image using a lens, or for the purpose of optical measurement or image propagation or transmission. For example, the optical instrument according to the embodiment may be a cellular phone, a mobile phone, a smartphone, a portable smart device, a digital camera, a laptop computer, a digital broadcasting terminal, a personal digital assistant (PDA), a portable multimedia player (PMP), a navigation device, etc., without being limited thereto, and may also be any of devices for capturing images or pictures.

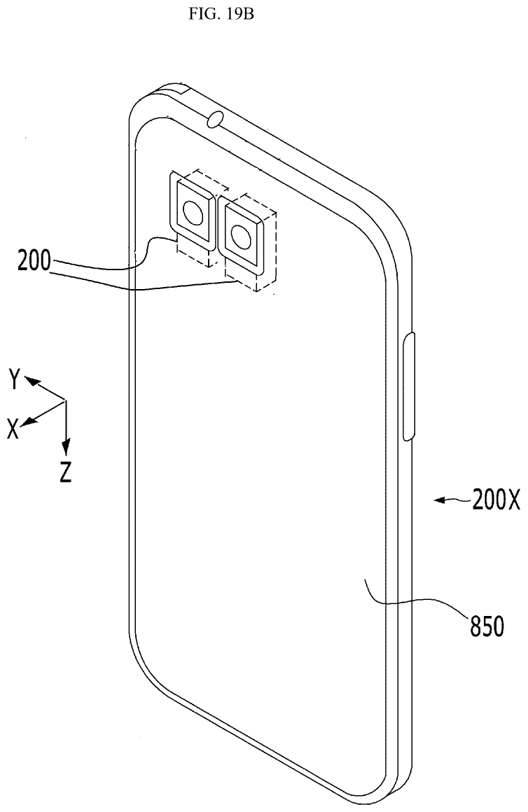

FIG. 19a is a perspective view of the optical device 200A according to an embodiment, FIG. 19b is a perspective view of the optical device 200X according to another embodiment, and

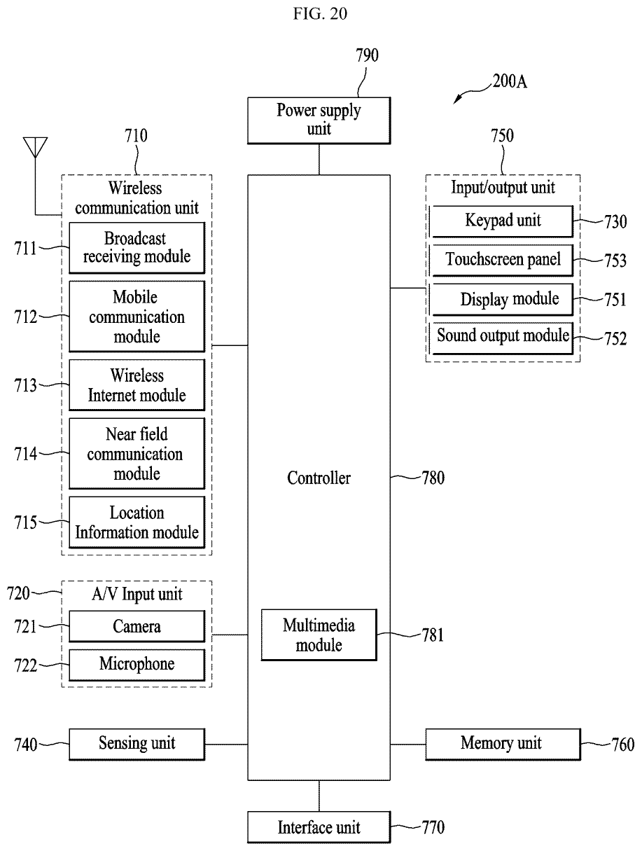

FIG. 20 is a configuration diagram of the optical device 200A shown in FIG. 19A and FIG. 19B.

For example, the embodiment of FIG. 19A may be a front camera of the camera module 200 in which the lens module 400 is disposed to face a front surface of the body 850 of the optical device 200A, and the embodiment of FIG. 19B may be a rear camera in which the module 400 is disposed to face a rear surface of the body 850 of the optical device 200A. FIG. 19B shows an example of two rear cameras being disposed, but in another embodiment, an optical device may have one or more rear camera.

In another embodiment, the camera device 200 may correspond to the front camera and the rear camera of the optical device 200A.

Referring to FIGS. 19A, 19B and 20, the optical device 200A may include a body 850, a wireless communication unit 710, an A/V input unit 720, a sensing unit 740, an input/output unit 750, a memory unit 760, an interface unit 770, a controller 780, and a power supply unit 790.

The body 850 has a bar shape, however, the disclosure is not limited thereto. The body may have any of various structures, such as a slide type structure, a folder type structure, a swing type structure, and a swivel type structure, in which two or more sub-bodies are coupled so as to be movable relative to each other.

The body 850 may include a case (casing, housing, cover, etc.) that defines the external appearance thereof. For example, the body 850 may be divided into a front case 851 and a rear case 852. Various electronic parts of the terminal may be mounted in a space defined between the front case 851 and the rear case 852.

The wireless communication unit 710 may include one or more modules that enable wireless communication between the optical device 200A and a wireless communication system or between the optical device 200A and a network in which the optical device 200A is located. For example, the wireless communication unit 710 may include a broadcast receiving module 711, a mobile communication module 712, a wireless Internet module 713, a nearfield communication module 714, and a location information module 715.

The audio/video (A/V) input unit 720, which is configured to input an audio signal or a video signal, may include a camera 721 and a microphone 722.

The camera 721 may be the camera device 200 according to the embodiment

The sensing unit 740 may sense the current state of the optical device 200A, such as the opening and closing state of the optical device 200A, the position of the optical device 200A, whether a user contacts the terminal, the orientation of the optical device 200A, and acceleration/deceleration of the optical device 200A, in order to generate a sensing signal for controlling the operation of the optical device 200A. For example, when the optical device 200A is a slide phone, the sensing unit may sense whether the slide phone is open or closed. In addition, the sensing unit senses whether electric power is supplied from the power supply unit 790 and whether the interface unit 770 is coupled to an external instrument.

The input/output unit 750 is configured to generate input or output related to visual sensation, audible sensation, or tactile sensation. The input/output unit 750 may generate input data for controlling the operation of the optical device 200A, and may display information processed by the optical device 200A.

The input/output unit 750 may include a keypad unit 730, a display module 751, a sound output module 752, and a touchscreen panel 753. The keypad unit 730 may generate input data through keypad input.

The display module 751 may include a plurality of pixels, the color of which is changed according to an electrical signal. For example, the display module 751 may include at least one of a liquid crystal display, a thin film transistor-liquid crystal display, an organic light-emitting diode, a flexible display, and a three-dimensional (3D) display.

The sound output module 752 may output audio data received from the wireless communication unit 710 in a call signal reception mode, a telephone communication mode, a recording mode, a voice recognition mode, or a broadcast reception mode, or may output audio data stored in the memory unit 760.

The touchscreen panel 753 may convert a change in capacitance due to a user's touch on a specific region of the touchscreen into an electrical input signal.

The memory unit 760 may store a program for processing and control of the controller 780, and may temporarily store input/output data (for example, a telephone directory, messages, audio, still images, photographs, and video). For example, the memory unit 760 may store images, such as photographs or video, taken by the camera 721. For example, the memory unit 760 can store software, algorithms, or mathematical formulas for the above-described hand shake correction.

The interface unit 770 functions as a path for connection between the optical device 200A and an external instrument. The interface unit 770 may receive data or electric power from the external instrument and transmit the received data or electric power to internal components of the optical device 200A, or may transfer data in the optical device 200A to the external instrument. For example, the interface unit 770 may include a wired/wireless headset port, an external charger port, a wired/wireless data port, a memory card port, a port for connection with an apparatus having an identification module, an audio input/output (I/O) port, a video input/output (I/O) port, and an earphone port.

The controller 780 may control the overall operation of the optical device 200A. For example, the controller 780 may perform related control and processing for voice communication, data communication, and video communication.

The controller 780 may have a multimedia module 781 for multimedia reproduction. The multimedia module 781 may be implemented in the controller 180 or may be implemented separately from the controller 780.

The controller 780 may perform pattern recognition processing that is capable of recognizing writing input or drawing input performed on the touchscreen as text or an image, respectively.

The power supply unit 790 may supply power required to operate the respective components upon receiving external power or internal power under the control of the controller 780.

The features, structures, and effects described in the above embodiments are included in at least one embodiment, but are not limited only to one embodiment. Furthermore, features, structures, and effects illustrated in each embodiment may be combined or modified in other embodiments. Therefore, it is to be understood that such combinations and modifications fall within the scope of the present disclosure.

### Industrial Applicability

The embodiments are applicable to camera device and optical device that can reduce a distance between an image sensor and a lens barrel and a length in the optical axis direction, and improve heat dissipation efficiency.

1. A camera device comprising:
a stationary unit comprising a second circuit board and a coil disposed on the second circuit board;
a moving unit comprising a holder, a magnet coupled to the holder, a first circuit board disposed on the holder, and an image sensor conductively connected to the first circuit board; and
a support board disposed between the first circuit board and the second circuit board such that the moving unit is movable relative to the stationary unit,
wherein the magnet is disposed between the first circuit board and the second circuit board.

2. The camera device according to claim 1, wherein the image sensor is positioned higher than the magnet.

3. The camera device according to claim 1, wherein the stationary unit comprises a heat dissipation member disposed between the image sensor and the second circuit board.

4. The camera device according to claim 1, wherein the holder comprises a recess formed a lower surface thereof, and the magnet is disposed in the recess of the holder.

5. The camera device according to claim 1, wherein the first circuit board comprise a terminal disposed on an upper surface thereof and conductively connected to the image sensor.

6. The camera device according to claim 1, wherein a groove is formed in an upper surface of the holder, and the first circuit board is disposed in the recess of the holder.

7. The camera device according to claim 1, wherein the moving unit comprise a third circuit board disposed on the first circuit board, and the image sensor is conductively connected to the third circuit board.

8. The camera device according to claim 7, wherein the image sensor is disposed at an upper side of the first circuit board.

9. The camera device according to claim 7, wherein a lower surface of the image sensor is positioned higher than an upper surface of the first circuit board.

10. The camera device according to claim 7, wherein the third circuit board comprise an opening,
wherein at least a portion of the image sensor is disposed in the opening of the third circuit board.
